(19) United States
(12) Patent Application Publication
(10) Pub. No.: US 2012/0121468 A1
(43) Pub. Date: May 17, 2012

(54) System For The Conversion Of Carbonaceous Feedstocks To A Gas Of A Specified Composition

(75) Inventors: Andreas Tsangaris, Ottawa (CA); Kenneth C. Campbell, Kitchener (CA); D. Michael Feasby, Ottawa (CA); Ke Li, Ottawa (CA)

(73) Assignee: PLASCO ENERGY GROUP INC., Kanata (CA)

(21) Appl. No.: 13/235,665

(22) Filed: Sep. 19, 2011

Related U.S. Application Data
(62) Division of application No. 11/916,417, filed on May 15, 2008, now abandoned.
(60) Provisional application No. 60/687,475, filed on Jun. 3, 2005.

(51) Int. Cl. B01J 7/00

(52) U.S. Cl. 422/105

(57) ABSTRACT

The present invention provides a carbonaceous feedstock gasification system with integrated control subsystem. The system generally comprises, in various combinations, a gasification reactor vessel (or converter) having one or more processing zones and one or more plasma heat sources, a solid residue handling subsystem, a gas quality conditioning subsystem, as well as an integrated control subsystem for managing the overall energetics of the conversion of the carbonaceous feedstock to energy, as well as maintaining all aspects of the gasification processes at an optimal set point. The gasification system may also optionally comprise a heat recovery subsystem and/or a product gas regulating subsystem.

### RELATED APPLICATIONS

This application is a divisional application of U.S. application Ser. No. 11/916,417, filed May 15, 2008, entitled “System For The Conversion Of Carbonaceous Feedstocks To A Gas Of A Specified Composition.” U.S. application Ser. No. 11/916,417 is a 35 U.S.C. §371 national phase application of PCT/CA2006/000881 (WO 2006/128285), filed on Jun. 5, 2006, which application claims the benefit of U.S. Provisional Application Ser. No. 60/687,475, filed Jun. 3, 2005, which applications are incorporated herein by reference in their entirety.

### FIELD OF THE INVENTION

This invention relates to the gasification of carbonaceous feedstocks, and in particular to a process and apparatus for the conversion of carbonaceous feedstocks to a gas having a specified composition.

### BACKGROUND OF THE INVENTION

Gasification is a process that enables the production of a combustible or synthetic gas (e.g., H₂, CO, CO₂, CH₄) from carbon-based feedstock, referred to as carbonaceous feedstock. The gas can be used to generate electricity or as a basic raw material to produce chemicals and liquid fuels. This process enables the production of a gas that can be used for generation of electricity or as primary building blocks for manufacturers of chemicals and transportation fuels.

In particular, the gas can be used, for: the combustion in a boiler for the production of steam for internal processing and/or other external purposes; for the generation of electricity through a steam turbine; the combustion directly in a gas turbine or a gas engine for the production of electricity; fuel cells; the production of methanol and other liquid fuels; as a further feedstock for the production of chemicals such as plastics and fertilizers; the extraction of both hydrogen and carbon monoxide as discrete industrial fuel gases; and other industrial heat requirements as required.

As useful feedstocks for the gasification process can be any carbonaceous material, the types of feedstock can range broadly. Useful feedstocks can include, but are not limited to, any waste materials, coal, petroleum coke, heavy oils, biomass and agricultural wastes.

Generally, a gasification process consists of feeding carbon-containing materials into a heated chamber (the gasifier) along with a controlled and limited amount of oxygen and steam. At the high operating temperature created by conditions in the gasifier, chemical bonds are broken by thermal energy and by partial oxidation, and inorganic mineral matter is fused or vitrified to form a molten glass-like substance called slag.

Gasification (the complete conversion of carbonaceous feedstock to off-gas and then to syngas) can proceed at high temperature or low temperature, high pressure or low pressure and in one step or where the stages are separated to some degree under conditions (temperature, process additives) in a manner that certain reactions are favored over another. It can occur in one chamber, multiple regions within one chamber or multiple chambers. As the feedstock proceeds through a gasification reactor, physical, chemical, and thermal processes may occur sequentially or simultaneously, depending on the reactor design and the composition of the feedstock. Drying occurs as the feedstock is heated and its temperature increases, water is the first constituent to evolve.

As the temperature of the dry feedstock increases, pyrolysis takes place. During pyrolysis the feedstock is thermally decomposed to release tars, phenols, and light volatile hydrocarbon gases while the feedstock is converted to char. Depending on the origin of the feedstock, the volatiles may include H₂O, H₂, N₂, O₂, CO₂, CO, CH₄, H₂S, NH₃, C₂H₆ and very low levels of unsaturated hydrocarbons such as acetylenes, olefins, aromatics and tars. Once a carbonaceous material is converted to a gaseous state, undesirable substances such as sulfur compounds and ash may be removed from the gas.

Char comprises the residual solids consisting of organic and inorganic materials. After pyrolysis, the char has a higher concentration of carbon than the dry feedstock and may serve as a source of activated carbon.

Gasification products are the result of chemical reactions between carbon in the char and steam, CO₂, and H₂ in the vessel as well as the chemical reactions between the resulting gases. The gasification reaction is driven by heat (pyrolysis). This can be fueled by adding electricity or fossil fuels (eg. propane) to heat the reaction chamber or adding air as a reactant to drive the exothermic gasification reaction, which provides heat to the reaction. Some gasification processes also use indirect heating, avoiding combustion of the feed material in the gasification reactor and avoiding the dilution of the product gas with nitrogen and excess CO₂.

The means of accomplishing a gasification process vary in many ways, but rely on four key engineering factors: the atmosphere (level of oxygen or air or steam content) in the reactor; the design of the reactor; the internal and external heating means; and the operating temperature for the process. The products of include hydrocarbon gases (also called syngas), hydrocarbon liquids (oils) and char (carbon black and ash).

Some gasification systems employ plasma technology. Plasma is a fourth state of matter: an ionized gas resulting, e.g., from electric discharges. The plasma torch heats the gas molecules to such a high temperature that the molecules disassociate into their constituent atoms. Process heat is recovered from the hot stream of atoms leaving the plasma generator and the temperature of the stream of atoms is lowered to a point where some of the atoms begin to recombine. Since the input gases are stoichiometrically deficient in oxygen, there is sufficient oxygen to produce a substantial quantity of carbon monoxide but insufficient oxygen to produce a substantial quantity of carbon dioxide.

The very high temperatures (3000 to 7000° C.) achievable with plasma arc torches enable a gasification process where virtually any input feedstock including waste in as-received condition, including liquids, gases, and solids in any form or combination can be accommodated. Feedstock can range from bulky municipal solid waste (MSW) such as household appliances, tires, bedsprings to waste materials such as low-level radioactive waste.

The plasma torches (technology) can be positioned to make all the reactions happen simultaneously, or can be positioned within the reaction vessel to make them happen sequentially. In either configuration, the temperature of the pyrolysis process is elevated due to inclusion of plasma torches (technology) in the reactor.

The means of accomplishing a gasification process vary in many ways, but rely on four key engineering factors: the atmosphere (level of oxygen, air or steam content) in the reactor; the design of the reactor; the design of the heating system; and the operating temperature for the process. Factors that affect the quality of the product gas include: feedstock composition, preparation and particle size; reactor heating rate; residence time; the plant configuration including whether it employs a dry or slurry feed system, the feedstock-reactant flow geometry, the design of the dry ash or slag mineral removal system; whether it uses a direct or indirect heat generation and transfer method; and the syngas cleanup system.

These factors have been taken into account in the design of various different systems, which have been proposed for using plasma arc generators to convert waste into electricity in an energy efficient manner. These systems are described, for example, in U.S. Pat. Nos. 6,686,556, 6,630,113, 6,380,507; 6,215,678, 5,666,891, 5,798,497, 5,756,957, and U.S. Patent Application Nos. 2004/0251241, 2002/0144981.

There are also a number of patents relating to different technologies for the gasification of coal for the production of synthesis gases for use in various applications, including U.S. Pat. Nos. 4,141,694; 4,181,504; 4,208,191; 4,410,336; 4,472,172; 4,606,799; 5,331,906; 5,486,269, and 6,200,430.

The gas produced during the gasification of carbonaceous feedstock is usually very hot and dirty, and requires further treatment to convert it into a useable product. For example, wet scrubbers and dry filtration systems are often used to remove particulate matter and acid gases from the gas produced during gasification. A number of gasification systems have been developed which include systems to treat the gas produced during the gasification process.

U.S. Pat. No. 6,810,821 describes an apparatus and method for treating the gas byproduct of a waste treatment system using a plasma torch which employs a nitrogen-free working gas. U.S. Pat. No. 5,785,923 describes an apparatus for continuous feed material melting which includes an off-gas receiving chamber having an off-gas heater, such as a plasma torch, for destroying the volatile material.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system for the conversion of a carbonaceous feedstock to a gas of a specified composition, comprising: a gasification reaction vessel comprising: one or more processing zones, one or more plasma heat sources, one or more carbonaceous feedstock input means for adding the carbonaceous feedstock to the gasification reaction vessel at an adjustable carbonaceous feedstock feed rate one or more process additive input means for adding process additives to the gasification reaction vessel at an adjustable process additive feed rate, one or more carbon-rich material additive input means for adding carbon-rich material additives to the gasification reaction vessel at an adjustable carbon-rich material additives feed rate, and one or more outlets for the output gas, a solid residue handling subsystem; a gas quality conditioning subsystem; and an integrated control system comprising: system monitoring means for measuring one or more system parameters to generate data, computing means for collecting and analyzing the data generated by the system monitoring means, and output means to send appropriate signals to effect change in one or more system regulators located throughout the system, wherein the control system monitors the one or more system parameters and sends signals to the appropriate system regulators to effect change in the one or more system regulators and thereby produce a product gas of a specified composition.

### BRIEF DESCRIPTION OF THE DRAWINGS

These and other features of the invention will become more apparent in the following detailed description in which reference is made to the appended drawings.

FIGS. 1 to 3 are schematic diagrams depicting a system for the conversion of carbonaceous feedstocks to a gas of a specified composition in accordance with various exemplary embodiments of the present invention.

FIGS. 4 to 9 are schematic diagrams depicting various downstream applications for the system of FIGS. 1 to 3.

FIG. 10 is a flow diagram depicting monitoring and regulating information flow between the system of FIGS. 1 to 9 and an integrated system control subsystem operatively coupled thereto.

FIG. 11 is a schematic diagram depicting the integrated system control subsystem of FIG. 10.

FIG. 12 is a schematic diagram depicting exemplary monitoring and regulating signals respectively received from and transmitted to the system of FIGS. 1 to 9 by the integrated system control subsystem of FIG. 10.

FIG. 13 is a schematic diagram depicting exemplary monitoring and regulating access points of the integrated system control subsystem of FIG. 10 to various devices, modules and subsystems of the system of FIGS. 1 to 9.

FIGS. 14 and 15 are schematic diagrams depicting an exemplary embodiment of the integrated system control subsystem of FIGS. 10 to 13 for controlling inputs to a plasma gasification vessel of the system of FIGS. 1 to 9.

FIGS. 16 to 20 are schematic diagrams depicting various plasma gasification vessels for use with the system of FIGS. 1 to 9.

FIGS. 21 to 23 are schematic diagrams depicting exemplary heat recovery subsystem for use with the system of FIGS. 1 to 9.

FIG. 24 is a schematic diagram depicting in greater detail, a gas-to-gas heat exchanger of FIG. 23.

FIG. 25 is a schematic diagram depicting in greater detail, a heat recovery steam generator of FIG. 23.

FIG. 26 is a schematic diagram depicting an optional steam/water treatment subsystem for treating a steam/water output from the heat recovery steam generation system of FIGS. 1 to 9, and particularly of FIG. 1.

FIG. 27 is a schematic diagram depicting an embodiment of a gas quality conditioning Suit for use with the system of FIGS. 1 to 9.

FIG. 28 is a schematic diagram depicting various data inputs and outputs of a plasma gasification process simulation and system parameter optimization and modeling means, optionally used with the integrated control subsystem of FIGS. 10 to 15.

FIG. 29 is a schematic diagram depicting various processes occurring in a horizontal three zone gasification vessel in accordance with an embodiment of the present invention.

FIGS. 30 and 31 are schematic diagrams depicting various vertical plasma gasification vessels for use with the system of FIGS. 1 to 9.

FIGS. 32A and 32B are schematic diagrams depicting various processes occurring in a vertical three zone gasification vessel in accordance with an embodiment of the present invention.

### DETAILED DESCRIPTION OF THE INVENTION

Unless defined otherwise, all technical and scientific terms used herein have the same meaning as commonly understood by one of ordinary skill in the art to which this invention belongs.

As used herein, the term “about” refers to a +/−10% variation from the nominal value. It is to be understood that such a variation is always included in any given value provided herein, whether or not it is specifically referred to.

For the purposes of the present invention, the term syngas (or synthesis gas) refers to the product of a gasification process, and may include carbon monoxide, hydrogen, and carbon dioxide, in addition to other gaseous components such as methane and water.

As used herein, the term “feedstocks” and “carbonaceous feedstock” can be any carbonaceous material appropriate for gasifying in the present gasification process, and can include, but are not limited to, any waste materials, coal (including low grade, high sulfur coal not suitable for use in coal-fired power generators), petroleum coke, heavy oils, biomass, sewage sludge and agricultural wastes. Waste materials suitable for gasification include both hazardous and non-hazardous wastes, such as municipal waste, and wastes produced by industrial activity and biomedical wastes. Examples of biomass useful for gasification include, but are not limited to, waste or fresh wood, remains from fruit, vegetable and grain processing, paper mill residues, straw, grass, and manure.

The term “solid residue” means the solid by-product of the gasification of a carbonaceous feedstock. Such a solid residue generally comprises inorganic, incombustible materials present in carbonaceous materials, such as silicon, aluminum, iron and calcium oxides. Examples of a solid residue include char, ash and slag.

“Slag” means a non-leachable, non-hazardous, glass-like material which consists of inorganic, incombustible material present in carbonaceous materials. In high temperature conditions (1300° C.-1800° C.) the mineral matter becomes molten. The molten slag forms a glassy substance upon quenching or cooling. This material is suitable for a number of commercial uses.

As used herein, the term “exchange-air” refers to air after it has been heated using sensible heat from the hot product gas using a gas-to-air heat exchanger according to the present invention.

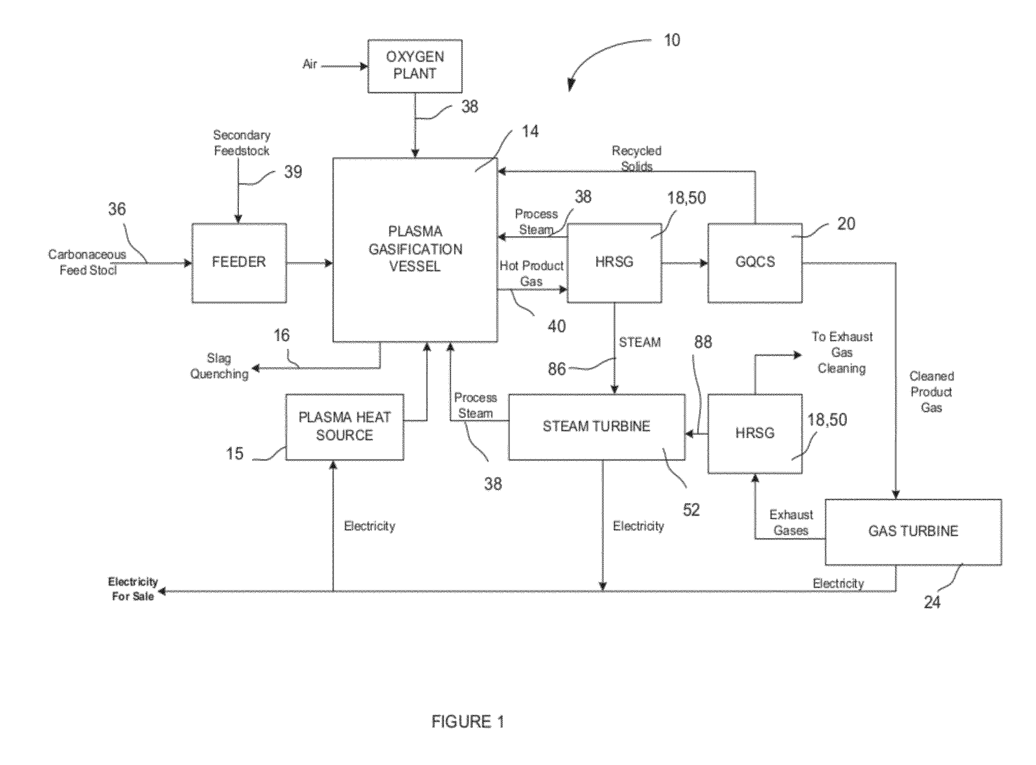

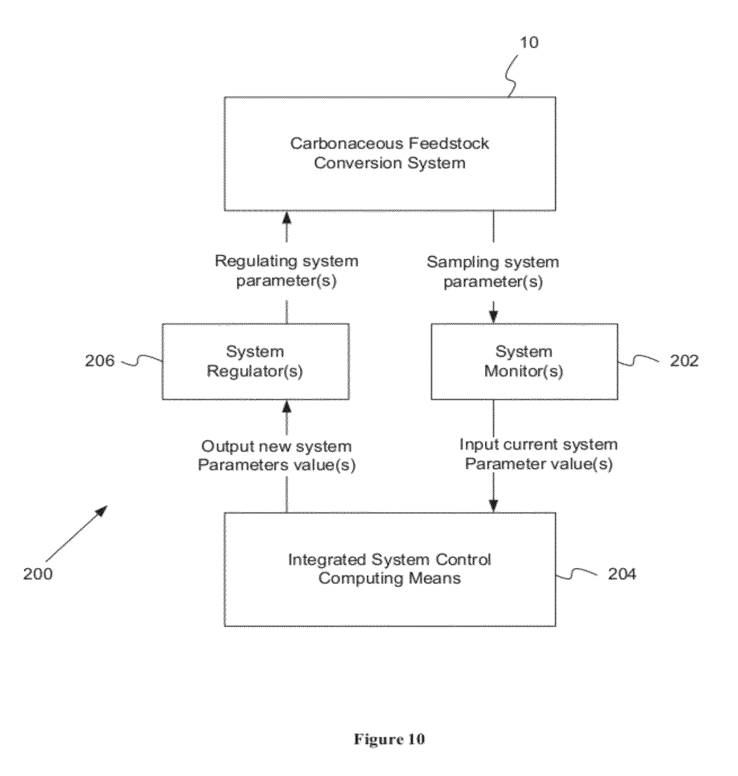

Referring now to FIGS. 1 to 9, the present invention provides a carbonaceous feedstock gasification system, generally referred to using the numeral 10, with integrated control subsystem 200, an exemplary embodiment of which is schematically illustrated in FIGS. 10 to 15. The system 10 generally comprises, in various combinations, a gasification reactor vessel 14 (or converter) having one or more processing zones and one or more plasma heat sources, as in 15, a solid residue handling subsystem 16, a gas quality conditioning subsystem 20, as well as an integrated control subsystem 200 for managing the overall energetics of the conversion of the carbonaceous feedstock to energy, as well as maintaining all aspects of the gasification processes at an optimal set point (illustratively depicted in FIGS. 10 to 15). The gasification system may also optionally comprise a heat recovery subsystem 18 and/or a product gas regulating subsystem 22 (e.g., a homogenization chamber 25 as in the embodiment of FIG. 1A, a gas compressor 21 as in the embodiments of FIGS. 1A and 1B, and/or a gas storage device 23 as in the embodiment of FIG. 1D, and the like).

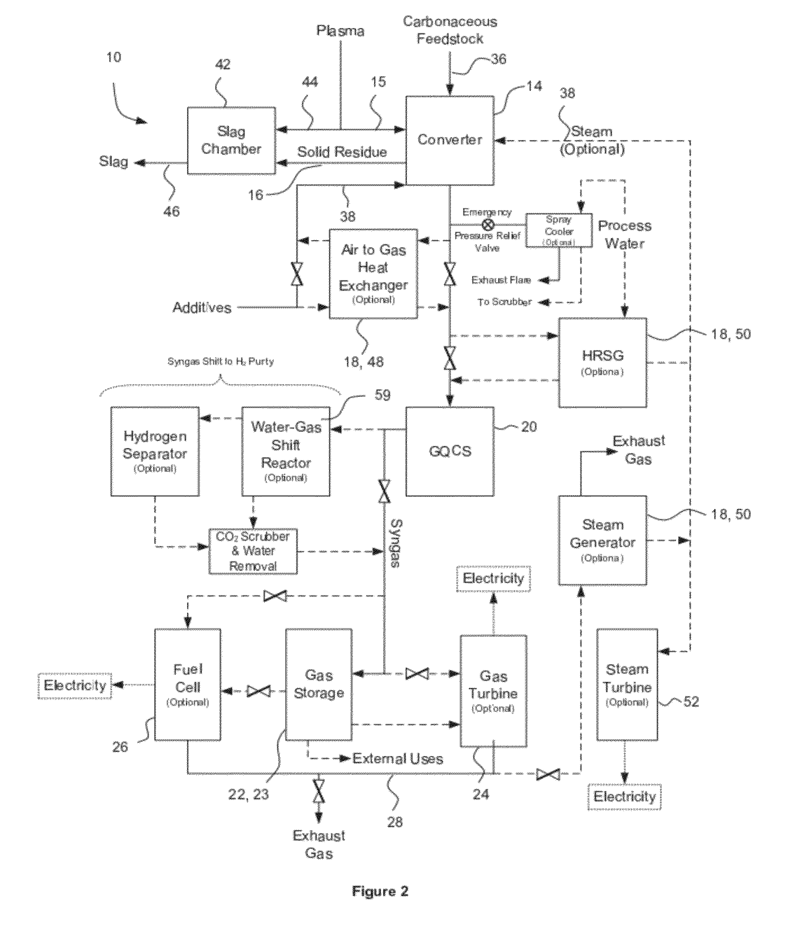

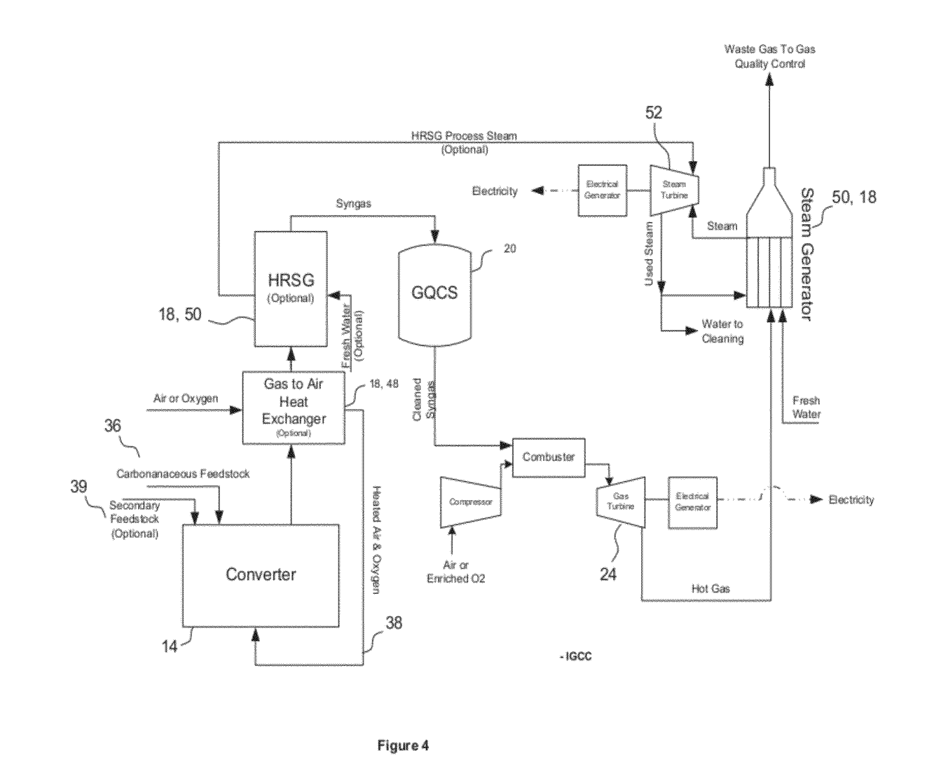

The various embodiments of the carbonaceous feedstock gasification system 10, with integrated control subsystem 200, convert a carbonaceous feedstock to a gas of a specified composition. In particular, the present invention provides a system which allows for the efficient conversion of a carbonaceous feedstock to a product gas having a composition appropriate for downstream applications (a exemplary number of which are schematically illustrated in FIGS. 4 to 9). For example, if the product gas is intended for use in the generation of electricity through combustion in a gas turbine (e.g. ref. 24 of FIGS. 1 to 6) or use in a fuel cell application (e.g. ref. 26 of FIGS. 2, 5 to 9), then it is desirable to obtain products which can be used as fuel in the respective energy generators. Alternatively, if the product gas is for use as a feedstock in further chemical processes (option 28 of FIG. 2), the composition will be that most useful for a particular synthetic application.

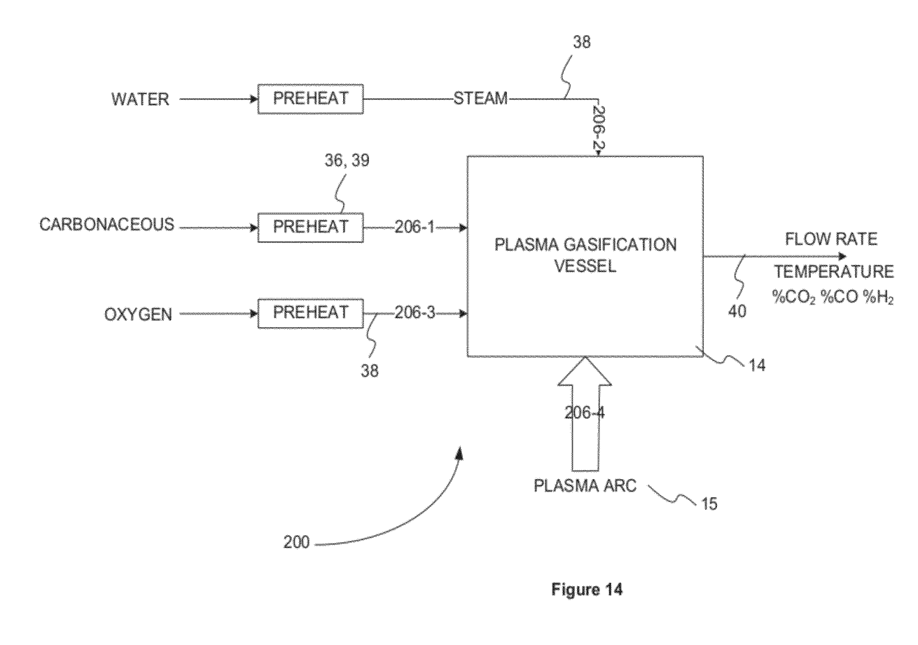

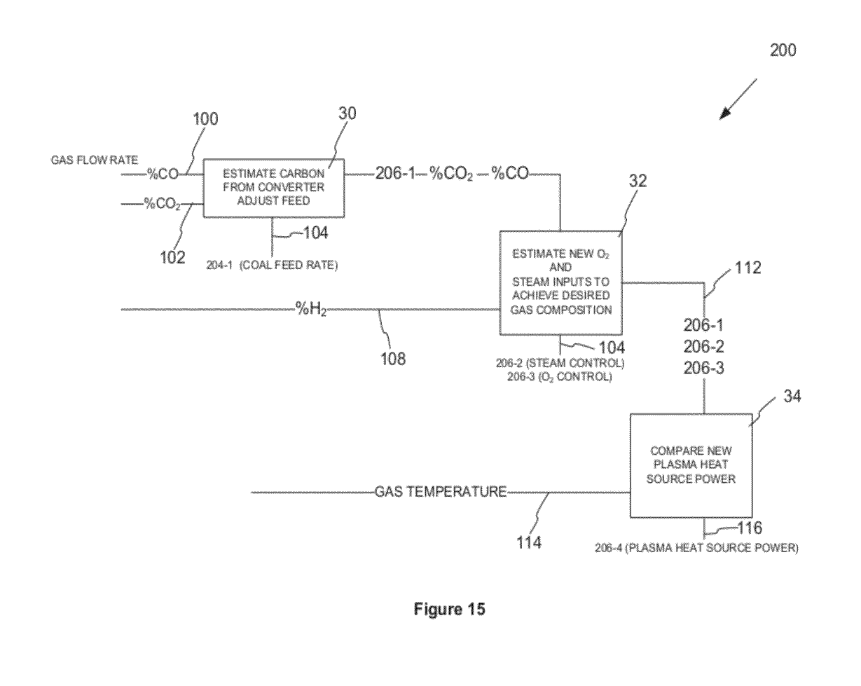

With reference to FIGS. 10 to 15, the integrated control subsystem 200 comprises system monitoring means 202 for measuring one or more system parameters (e.g. gas composition (% CO, % CO₂, % H₂, etc.), gas temperature, gas flow rate, etc.) and generating data from the measured system parameter values, as well as computing means 204 (schematically illustrated by the exemplary logic boxes 30, 32 and 34 in FIG. 15), for collecting and analyzing the data generated from the system monitoring means 202 and outputting appropriate signals to one or more of the system regulators 206 (i.e., regulators 206-1, 206-2, 206-3 and 206-4 of FIGS. 14 and 15). The integrated control subsystem 200 manages the energetics of the conversion of the carbonaceous feedstock to energy and maintains the processes at an optimum set point, by monitoring one or more system parameters via monitoring means 202, and sending signals to the appropriate system regulators 206 to make adjustments as required to maintain the reaction set point. Using the control subsystem 200 in accordance with the various embodiments of system 10 allows the production of a product gas having a specified composition.

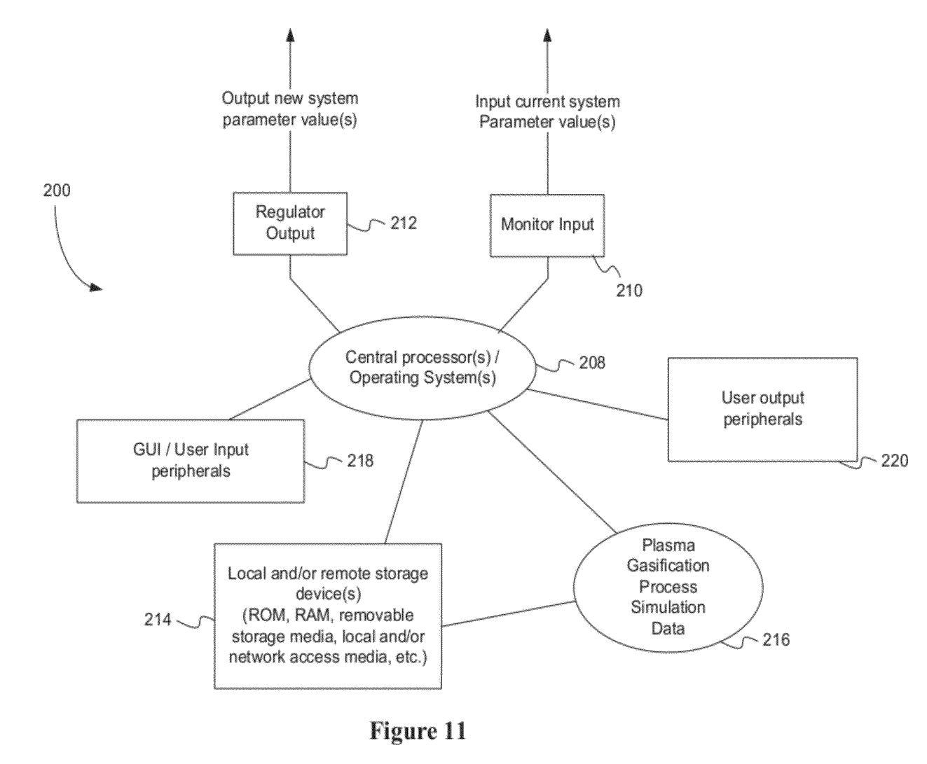

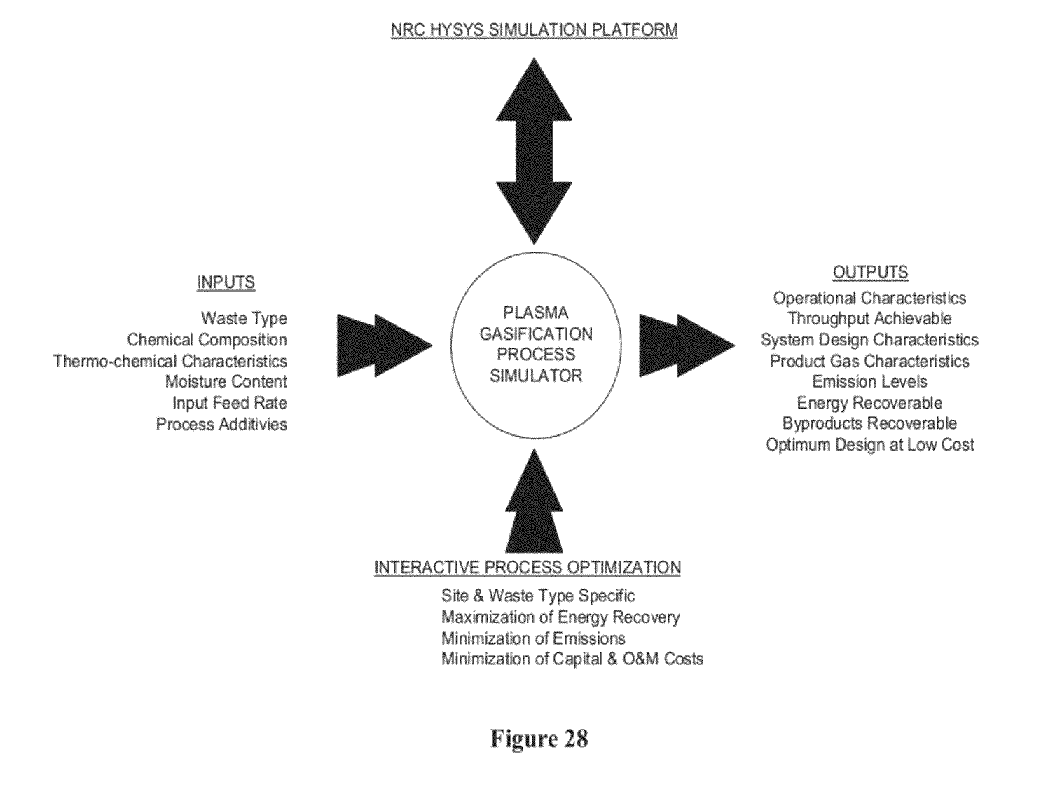

With reference to FIG. 11, the integrated control subsystem 200, and particularly the computing means thereof 204, is generally comprised of one or more processors 208, one or more monitor inputs 210 for receiving current system parameter values from the various monitoring means 202, and one or more regulator outputs 212 for communicating new or updated system parameter values to the various regulating means 206. The computing means 204 may also comprise one or more local and/or remote storage devices 214 (e.g. ROM, RAM, removable media, local and/or network access media, etc.) for storing therein various predetermined and/or readjusted system parameters, set or preferred system operating ranges, system monitoring and control software, operational data, and the like. Optionally, the computing means 204 may also have access, either directly or via various data storage devices, to plasma gasification process simulation data and/or system parameter optimization and modeling means 216, an exemplary representation of which are provided in FIG. 28. Also, the computing means 204 may be equipped with one or more graphical user interface and input peripherals 218 for providing managerial access to the control means 200 (system upgrades, maintenance, modification, adaptation to new system modules and/or equipment, etc.), as well as various output peripherals 220 for communicating data and information with external sources (e.g. modem, network connection, printer, etc.).

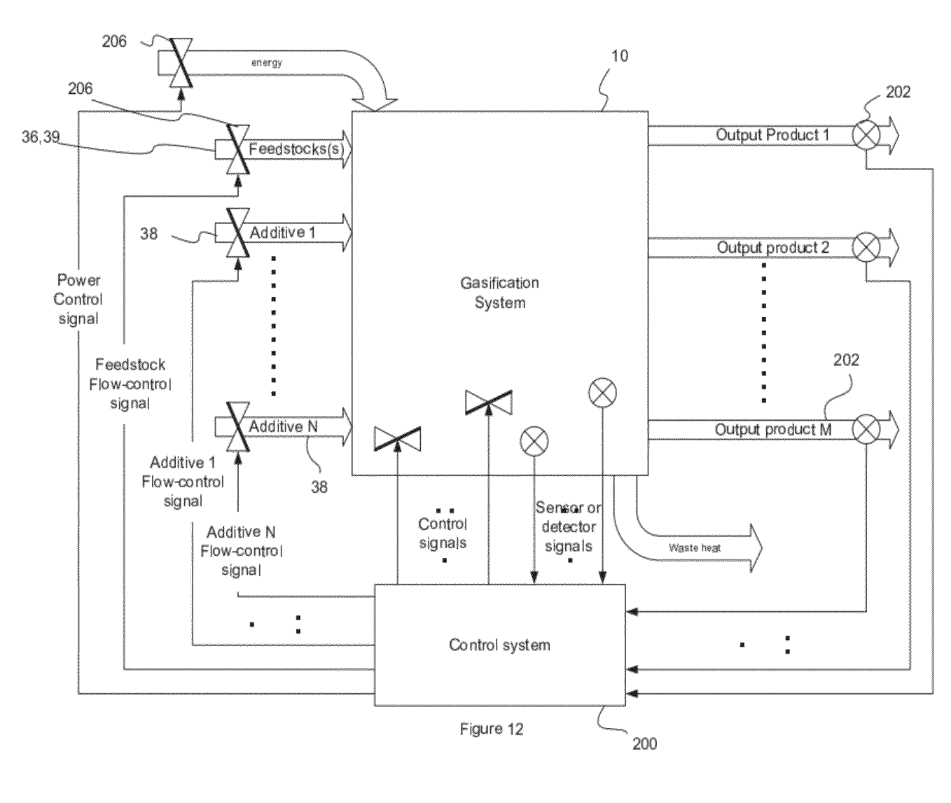

With reference to FIGS. 12 to 15, the control subsystem 200 of the present invention ensures that the gas flow and gas composition from the reaction vessel 14, and optionally throughout the system 10, remains within predefined tolerances to result in the optimum production of the product gas and of system byproducts (commercial slag, gas recovery, steam generation, etc.), irrespective of the composition of different types of feedstock or any natural variability in sources of the same type of feedstock. The control aspects of the present invention recognize and can make adjustments to compensate for such variability. The parameters of the product gas, such as temperature, flow rate and composition, are monitored, and the reactants are varied (e.g. via regulating means 206) to maintain the parameters of the product gas within predetermined tolerances as defined by the end use of the synthesis gas.

The integrated control subsystem 200 of the present invention provides corrective feedback by which one or more of the flow rate, temperature and composition of the product gas are monitored and corrections made to one or more of the carbonaceous feedstock input rate, the oxygen input rate, the steam input rate, the carbon-rich additive input rate and the amount of power supplied to the plasma heat sources 15. The adjustments are based on measured changes in the flow rate, temperature and/or composition of the product gas in order to ensure that these remain within acceptable ranges. In general, the ranges for the flow rate, temperature and/or composition of the product gas are selected to optimize the gas for a particular downstream application.

In one embodiment, the process of the present invention simultaneously uses the controllability of plasma heat to drive the gasification process, and to ensure that the gas flow and composition from the process remains within an acceptable range even if the composition of the feedstock exhibits natural variability. In another embodiment, the process allows for the total amount of carbon processed per unit time to be held as constant as possible, and utilizes the plasma heat to ensure that the total heat that enters and leaves the reaction vessel 14 per unit time is kept within process limits. The integrated control subsystem 200 may also be configured to monitor and/or regulate processes occurring via any one of the solid residue handling subsystem 16, the gas quality conditioning subsystem 20, the heat recovery subsystem 18 and/or the product gas regulating subsystem 22, as schematically illustrated in FIG. 14.

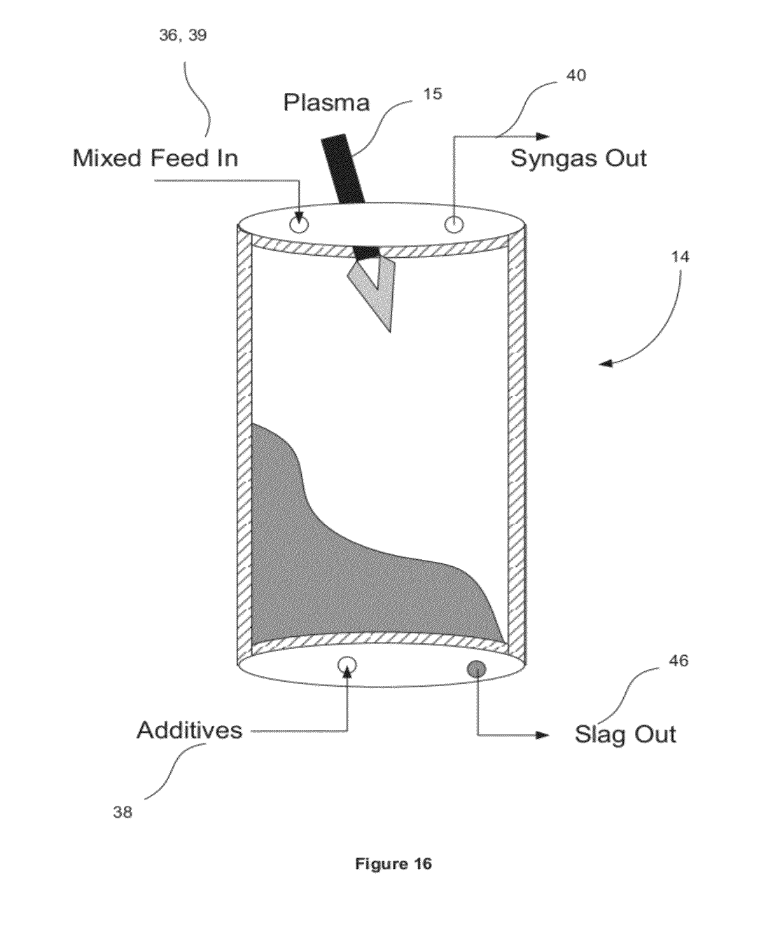

Referring back to FIGS. 1 to 9, the gasification of the carbonaceous feedstock generally takes place in the gasification reaction vessel 14 of the present invention, various exemplary embodiments of which are illustrated as vessels 14A to 14E in FIGS. 16 to 20. The gasification reaction vessel 14, in addition to the one or more processing zones and the one or more plasma heat sources 15, also comprises one or more means, as in 36, for inputting the feedstock (which may include a single feedstock, primary and secondary feedstocks and/or a mixed feedstock) into the gasification reaction vessel 14, as well as means, as in 38 and/or 39, for adding one or more process additives, such as steam, oxidant, and/or carbon-rich material additives (the latter of which is optionally provided as a secondary feedstock 39), as required for maintaining the gasification processes at an optimal set point. The gaseous products exit the gasification reaction vessel 14 via one or more output gas outlets, as in 40.

In one embodiment, the application of plasma heat (e.g. via a plasma heat 15 source such as a plasma torch and the like), in conjunction with the input of process additives, such as steam and/or oxygen and/or carbon-rich material (e.g. as a secondary feedstock 39, etc.), helps in controlling the gas composition. The system 10 may also utilize plasma heat to provide the high temperature heat required to gasify the feedstock and/or to melt the by-product ash and convert it to a glass-like product with commercial value.

Various embodiments of the present system 10 also provide means for managing the solid by-product of the gasification process. In particular, the invention provides a solid residue handling subsystem 16 for the conversion of the solid by-products, or residue, resulting from feedstock-to-energy conversion processes, into a vitrified, homogenous substance having low leachability. The solid by-products of the gasification process may take the form of char, ash, slag, or some combination thereof.

Illustratively the solid residue handling subsystem 16 comprises a solid residue conditioning chamber or region 42, a plasma heating means 44, a slag output means 46, and a controlling means (which may be operatively linked to the overall control subsystem 200 of the system 10), whereby plasma heat is used to cause solids to melt, blend and chemically react forming a dense silicometallic vitreous material that, when poured out of the chamber or region 42, cools to a dense, non-leachable, silicometallic solid slag. In particular, the invention provides a solid residue conditioning chamber or region 42 in which the solid residue-to-slag conversion is optimized using the integrated control subsystem to control the plasma heat rate and solid residue input rate to promote full melting and homogenization.

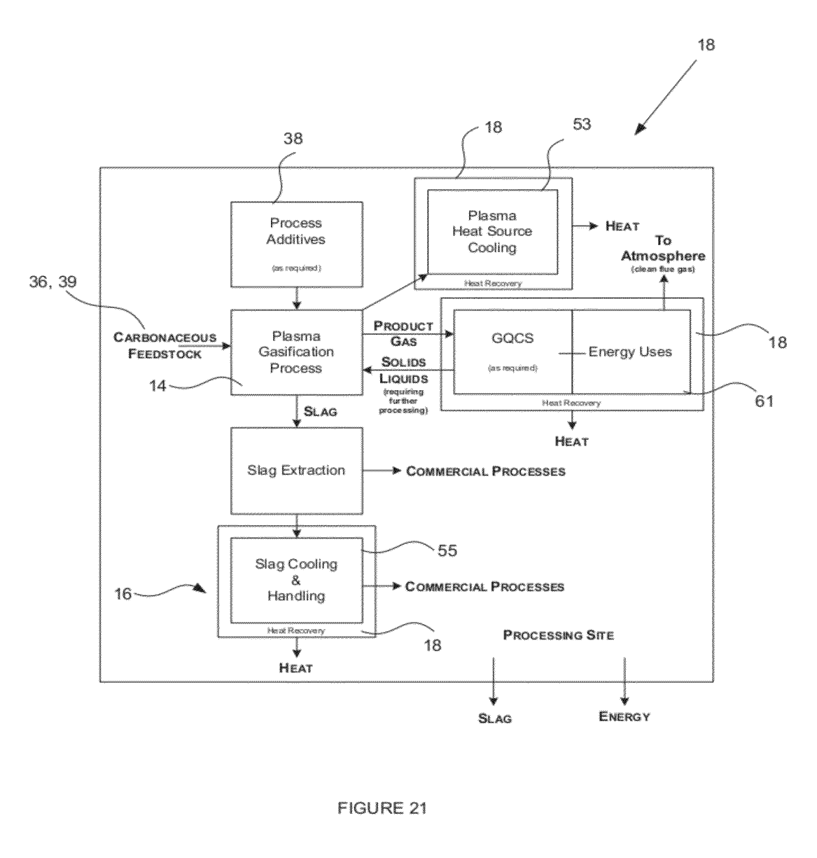

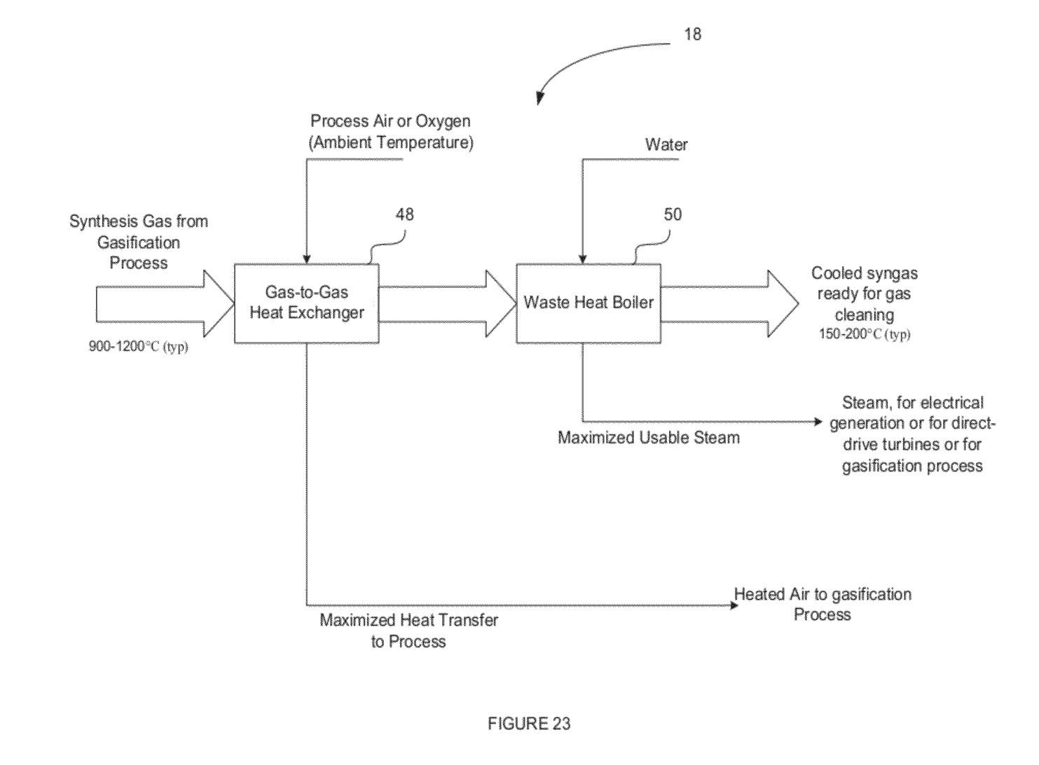

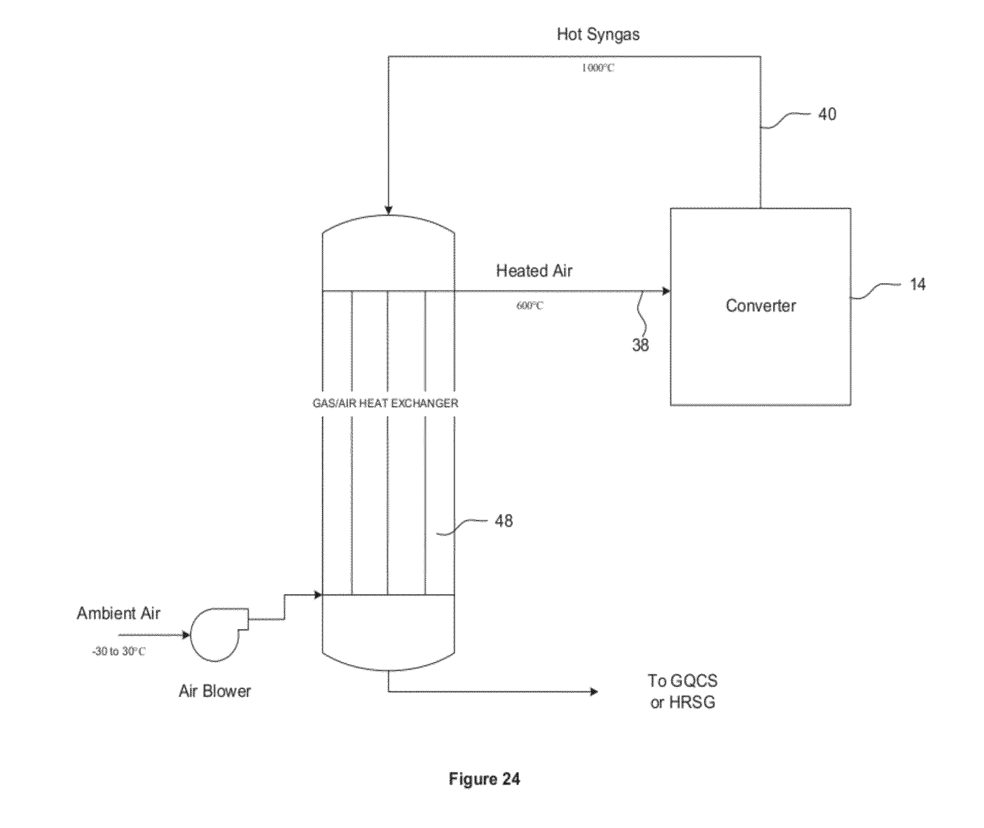

Various embodiments of the present system 10 also provide means for the recovery of heat from the hot product gas. This heat recovery subsystem 18 (exemplary embodiments of which are schematically illustrated in FIGS. 21 to 25) comprises means to transfer the hot product gases to one or more gas-to-air heat exchangers 48 whereby the hot product gas is used to heat air or other oxidant, such as oxygen or oxygen enriched air. The recovered heat, in the form of the heated air (or other oxidant), may then optionally be used to provide heat to the gasification process (FIGS. 23 and 24), thereby reducing the amount of heat which must be provided by the one or more plasma heat sources 15 to drive the gasification process. The recovered heat may also be used in industrial heating applications.

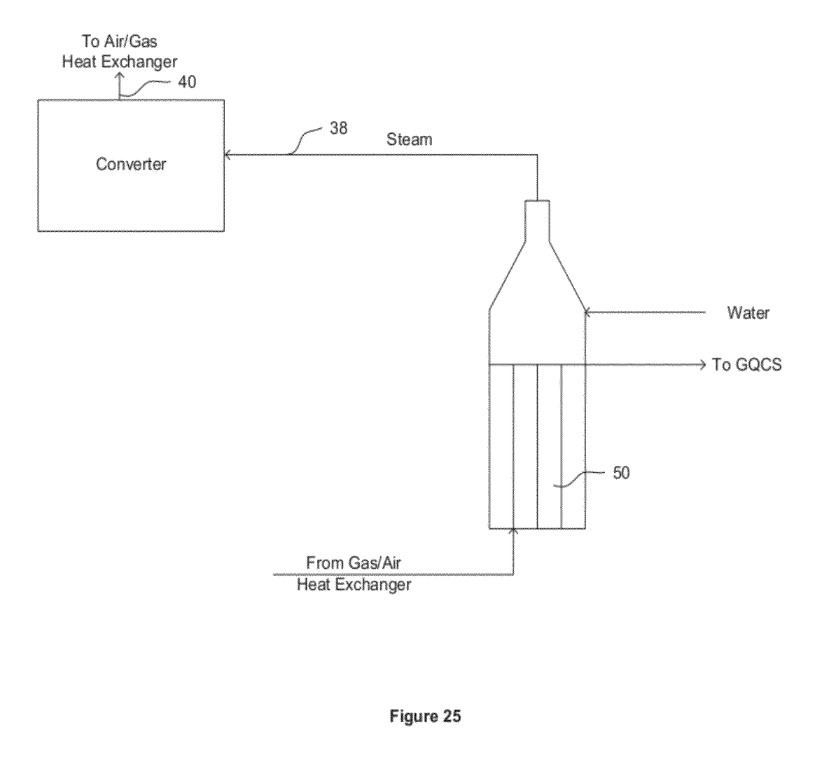

Optionally, the heat recovery subsystem additionally comprise one or more heat recovery steam generators (HRSG) 50 to generate steam which can, for example, be used as a process additive in the gasification reaction (FIGS. 23 and 25), or to drive a steam turbine, as in 52, to generate electricity.

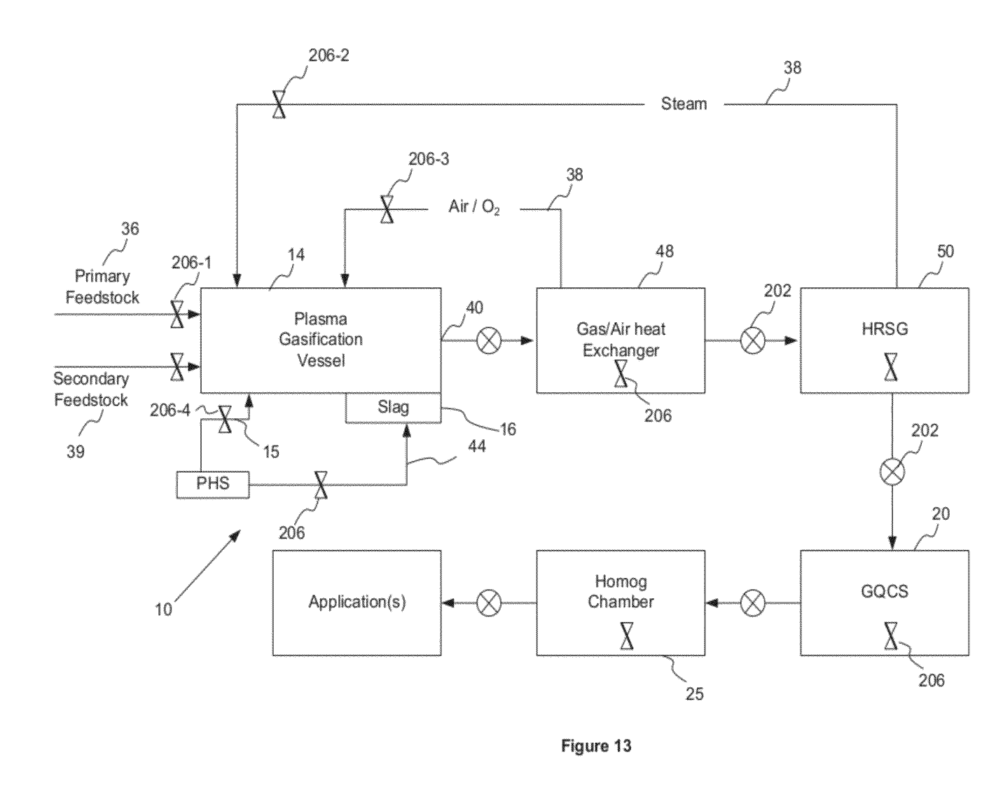

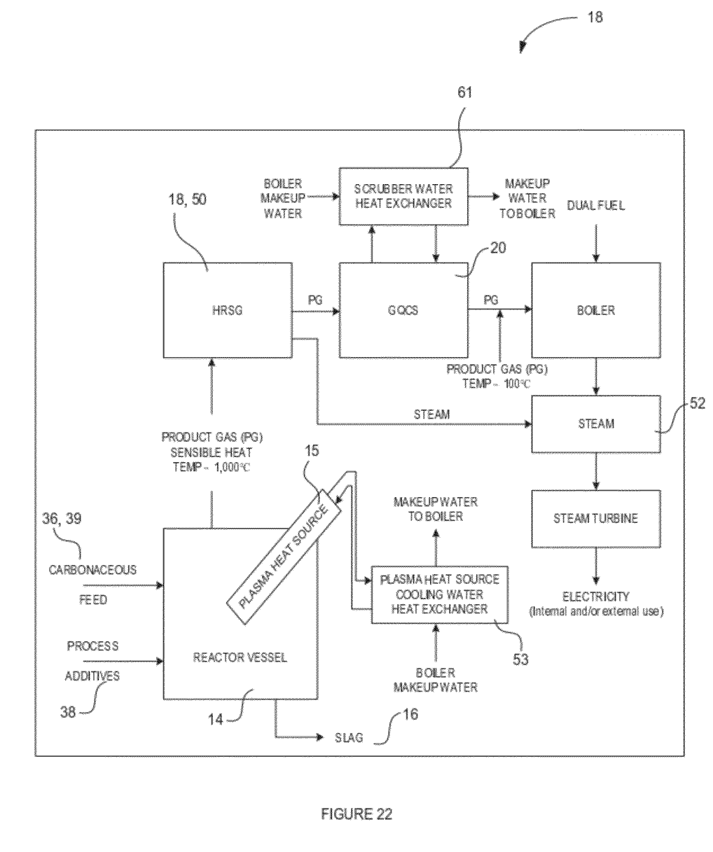

Also, as seen in FIGS. 21 and 22, the heat recovery subsystem 18 may also include additional heat recovery subsystems operatively extracting heat from various other system components and processes, such as via a plasma heat source cooling process 53, a slag cooling and handling process 55, GQCS cooling processes 61, and the like. The heat recovery system 18 may also comprise a feedback control system, which may be operatively coupled to the system's overall control subsystem 200, to optimize the energy transfer throughout the system 10 (e.g. see FIGS. 12 and 13).

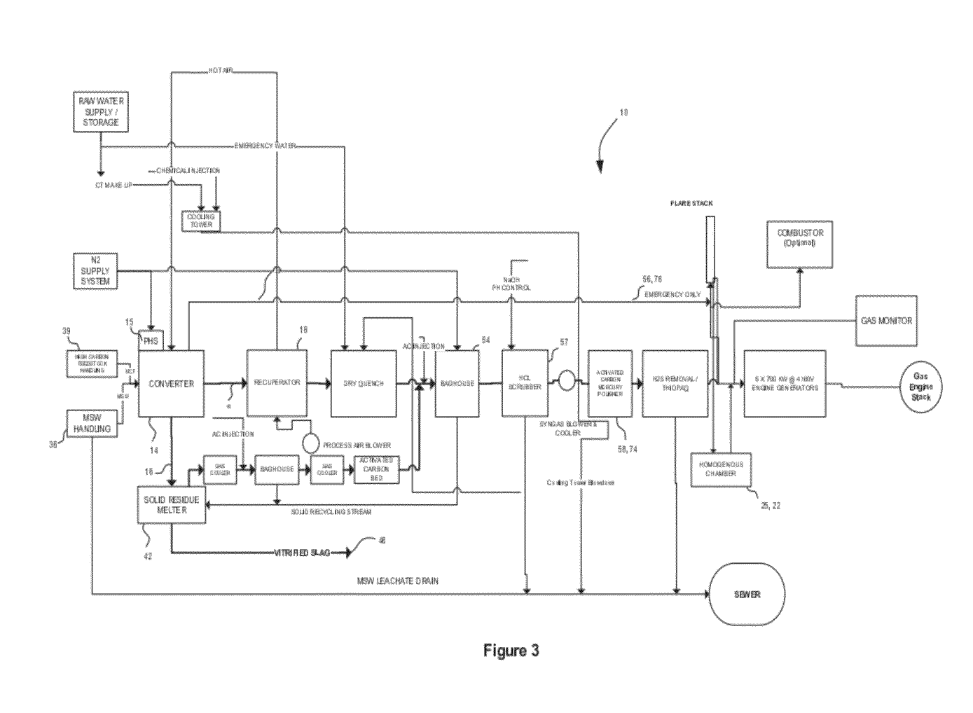

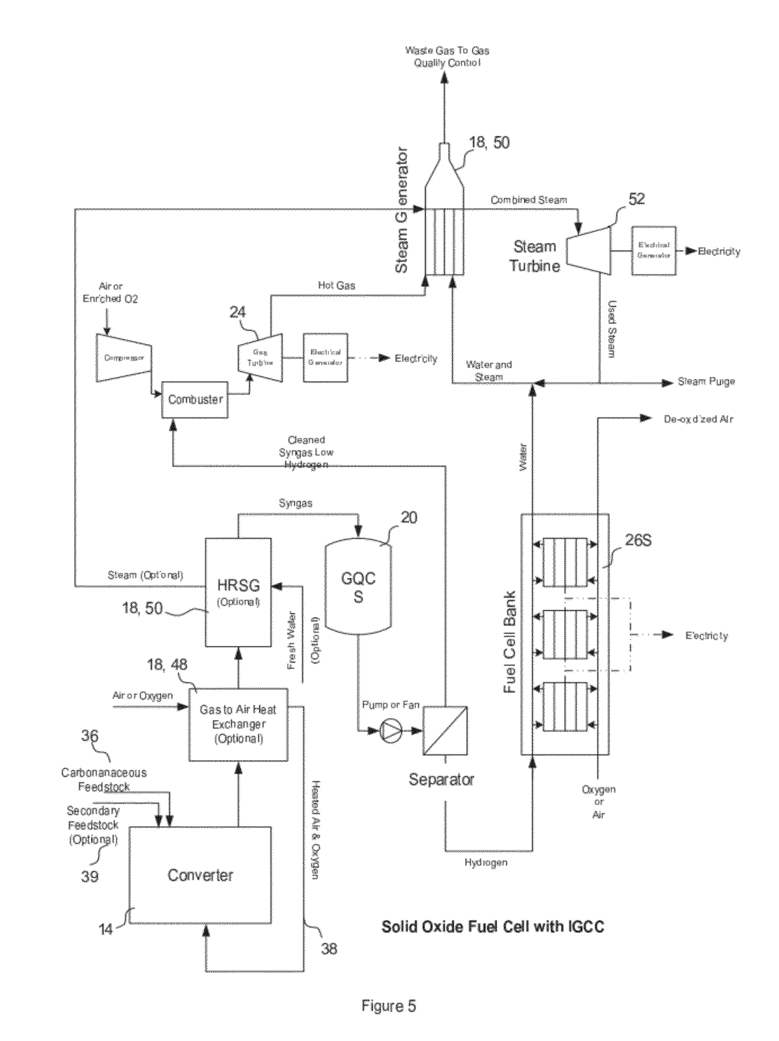

Various embodiments of the present gasification system 10 also provide a gas quality conditioning suite (GQCS) 20, or other such gas quality conditioning means (exemplary embodiments of which are illustrated in greater detail in FIGS. 3 and 5), to convert the product of the gasification process to an output gas of specified characteristics. The product gas is directed to the GQCS 20, where it is subjected to a particular sequence of processing steps to produce the output gas having the characteristics required for downstream applications. The GQCS 20 comprises components that carry out processing steps that may include, for example, removal of particulate matter 54 (e.g., via a baghouse, cyclone (FIG. 5) or the like), acid gases (HCl, H₂S) 56, and/or heavy metals 58 from the synthesis gas, or adjusting the humidity and temperature of the gas as it passes through the system 10. The presence and sequence of processing steps is determined by the composition of the synthesis gas and the specified composition of output gas for downstream applications. The gas quality conditioning system 20 may also comprise an integrated control subsystem, which may be operatively linked to the overall integrated control subsystem 200 of the system 10, to optimize the GQCS process (e.g. see FIGS. 12 and 13).

Various embodiments of the present gasification system 10 also provide a means, as in means 22, for regulating the product gas, for example, by homogenizing the chemical composition of the product gas and adjusting other characteristics such as flow, pressure, and temperature of the product gas to meet downstream requirements. This product gas regulating subsystem 22 enables a continual and steady stream of gas of defined characteristics to be delivered to downstream applications, such as a gas turbine 24 or engine, a fuel cell application 26, and the like.

In particular, the product gas regulating subsystem 22 of the present invention provides a gas homogenization chamber 25 (FIG. 3) or the like (compressor 21 of FIGS. 3, gas storage device 23 of FIG. 2, etc.) having dimensions that are designed to accommodate a gas residence time sufficient to attain a homogeneous gas of a consistent output composition. Other elements of the present product gas regulation system are designed to meet the gas performance requirements of the downstream application. The gas regulating system 22 may also comprises an integrated feedback control system, which may be operatively linked to the overall integrated control subsystem 200 of the system 10, to optimize the energetics and output of this process (e.g., see FIGS. 12 and 13).

With reference now to FIGS. 4 to 9, the person of skill in the art will understand that the present system 10 and integrated control subsystem 200, in their various embodiments, may be used in a number of energy generation and conversion systems having numerous independent and/or combined downstream applications. For instance, in the exemplary embodiment of FIG. 4, the system 10, an Integrated Gasification Combined Cycle (IGCC) system, may produce output energy (e.g. electricity) by providing both a syngas for use in one or more gas turbines 24, and steam, generated by cooling both the syngas and exhaust gas associated with the gas turbine 24 via one or more HRSG(s) 50, for use in one or more steam turbines 52.

In the exemplary embodiment of FIG. 5, the system 10 combines an Integrated Gasification Combined Cycle (IGCC) system with a solid oxide fuel cell system 26S, the latter of which using a hydrogen-rich byproduct of the syngas to produce energy (e.g. electricity).

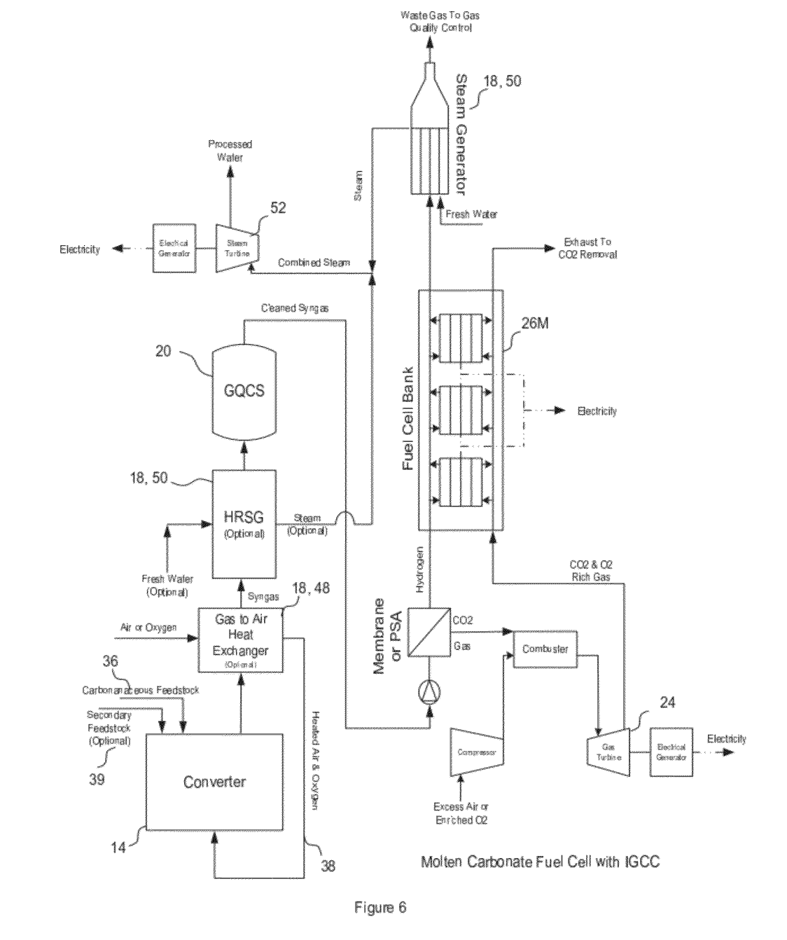

In the exemplary embodiment of FIG. 6, the system 10 combines an Integrated Gasification Combined Cycle (IGCC) system with molten carbonate fuel cell system 26M, the latter of which, as in FIG. 5, using a hydrogen-rich byproduct of the syngas to produce energy (e.g. electricity).

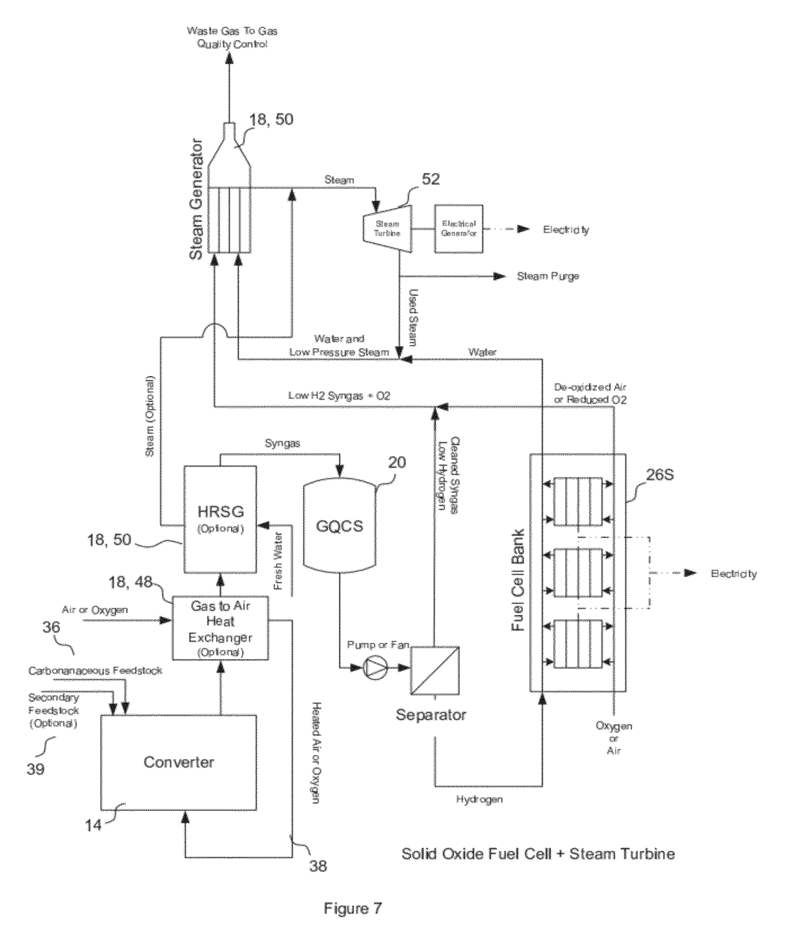

In the exemplary embodiment of FIG. 7, the system 10 combines a solid oxide fuel cell system 26S, as in FIG. 5, with one or more steam turbines 52 activated by steam generated by one or more HRSGs 50 recuperating heat from the syngas and the fuel cell output(s).

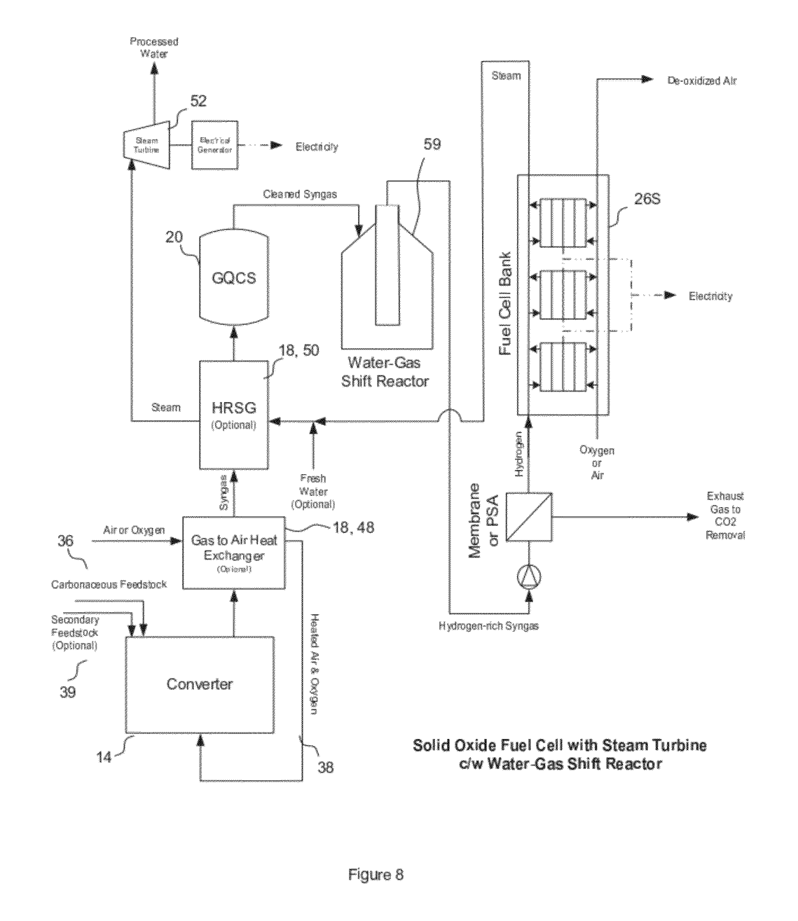

In the exemplary embodiment of FIG. 8, a water-gas shift reactor 59 is added to the embodiment of FIG. 7 to provide the hydrogen-rich syngas used in the solid oxide fuel cell system 26S.

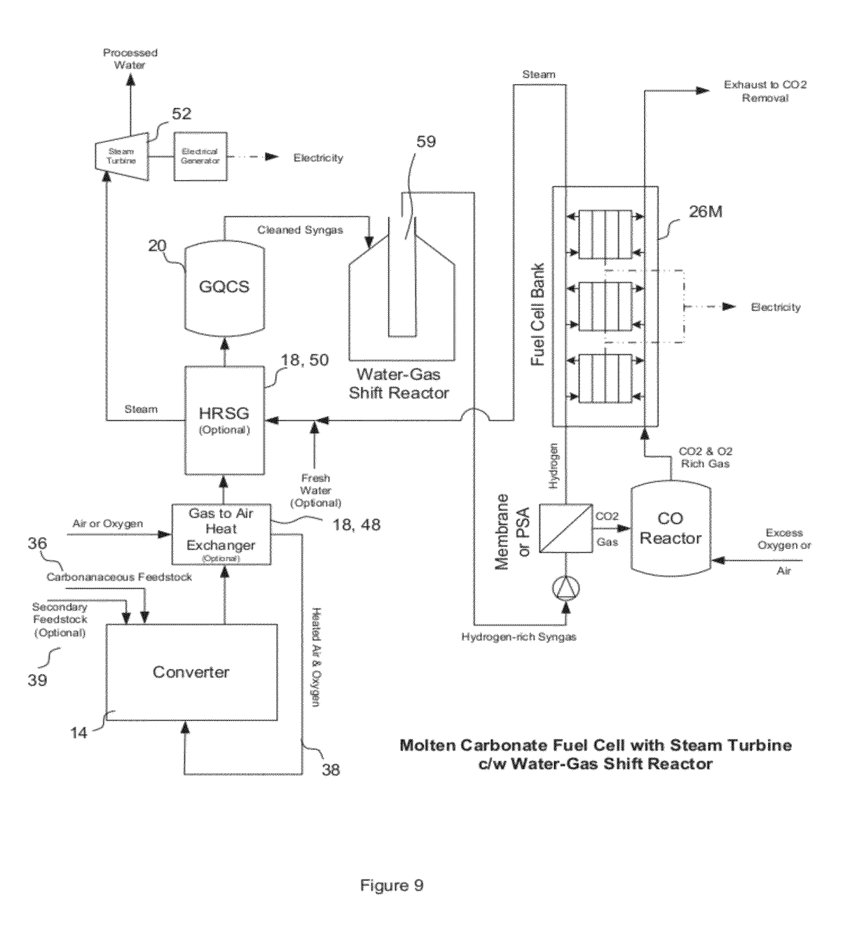

In the exemplary embodiment of FIG. 9, the solid oxide fuel cell system 26S of FIG. 8 is replaced by a molten carbonate fuel cell system 26M.

As will be apparent to the person of skill in the art, the above exemplary embodiments of system 10 are not meant to be limiting, as one of skill in the art will understand that other such system configurations and combinations can be provided without departing from the general scope and spirit of the present disclosure.

### Integrated Control Subsystem

With reference to FIGS. 1 to 3 and 10 to 15, the present system includes an integrated control subsystem 200. The integrated control subsystem 200 comprises system monitoring means 202 for measuring one or more system parameters to generate data, computing means 204 (schematically illustrated by the exemplary logic boxes 30, 32 and 34 in FIG. 15) for collecting and analyzing the data generated by the system monitoring means 202, and output means to send appropriate signals to effect change in one or more system regulators 206 located throughout the system (i.e., regulators 206-1, 206-2, 206-3 and 206-4 of FIGS. 14 and 15). The integrated control subsystem 200 monitors the system parameters and sends signals to the appropriate system regulators to make real time adjustments to various operating parameters and conditions as required in response to data obtained relating to measured parameters within the system 10. In one embodiment, the integrated control subsystem 200 provides a feedback control system to manage the energetics of the conversion of a carbonaceous feedstock to energy and maintain a reaction set point, thereby allowing the gasification processes to be carried out under optimum reaction conditions to produce a gas having a specified composition.

The overall energetics of the conversion of feedstock to gas can be determined and achieved using the present gasification system. Some factors influencing the determination of the net overall energetics are: the BTU value and composition of the feedstock, the specified composition of the product gas, the degree of variation allowed for the product gas, and the cost of the inputs versus the value of the outputs. Ongoing adjustments to the reactants (for example, power for the plasma heat source(s) 15 and/or 44, process additives 38 and/or 39, such as oxygen, steam, and/or carbon-rich material, the latter of which is optionally provided as a secondary feedstock 39, can be executed in a manner whereby the net overall energetics are assessed and optimized according to design specifications.

The control subsystem 200 of the present invention, therefore, provides a means for controlling in real time all aspects of the processes to ensure that the processes are carried out in an efficient manner, while managing the energetics and maintaining the reaction set point within certain tolerances. The real time controller is therefore capable of simultaneously controlling all aspects of the process in an integrated manner.

The composition and flow of product gas from the reaction vessel 14 is controlled within predefined tolerances by controlling the reaction environment. The temperature is controlled at atmospheric pressure to ensure that the feedstock that is injected into the reaction vessel 14 encounters as stable an environment as possible. The control subsystem 200 of this invention provides means to control the amounts of feedstock, steam, oxygen and carbon-rich material that are fed into the reaction vessel 14.

Operating parameters which may be adjusted to maintain the reaction set point include feedstock feed rate, process additive feed rate, power to induction blowers to maintain a specified pressure, and power to and position of the plasma heat sources (i.e. 15, 44). These control aspects will be discussed further having regard to each parameter.

With reference to FIGS. 12 and 13, and as briefly discussed above, the integrated control subsystem 200 may be integrated throughout the system 10 to monitor, via monitoring means 202, various system parameters, and implement, via regulating means 206, various modifications to these parameters to manage the energetics and maintain each aspect of the process within certain tolerances. These parameters, which will be discussed in greater detail below, may be derived from processes associated with one or more of the plasma gasification vessel 14, the solid residue handling subsystem 16, the plasma heat source(s) 15 and slag processing heat source(s) 44, the heat recovery subsystem 18 (e.g. gas-to-air heat exchanger 48 and/or HRSG 50) and process additive inputs 38 associated therewith, the primary and/or secondary feedstock inputs 36, 39 (e.g. carbon-rich additives), the GQCS 20, the homogenization chamber 25, and any other processing element or module of the system 10.

Furthermore, having access to these parameters and access, via the various local and/or remote storage devices 214 of computing means 204, to a number of predetermined and/or readjusted system parameters, system operating ranges, system monitoring and control software, operational data, and optionally plasma gasification process simulation data and/or system parameter optimization and modeling means 216 (e.g. see FIG. 28), the integrated control subsystem 200 may further interact with the system 10 in order to optimize system outputs.

### System Monitoring Means

With reference now to FIGS. 10 to 15, a number of operational parameters may be regularly or continuously monitored using the system monitoring means 202 of the control subsystem 200 to determine whether the system 10 is operating within the optimal set point. In one embodiment of the invention, means, as in means 202, are provided to monitor the parameters on a real time basis, thereby providing an instantaneous indicator of whether the system 10 is operating within the allowed/tolerated variability of the set point. The parameters which can be monitored include, but are not limited to, the chemical composition, flow rate and temperature of the product gas, the temperature at various points within the system 10, the pressure of the system, and various parameters relating to the plasma heat source(s) 15, 44 (i.e., power and/or position).

The parameters are monitored in real time and the resulting data are used to determine if, for example, more steam/oxygen (or other oxidants) must be injected into the system (e.g. via regulating means 206-2), if the feedstock input rate needs to be adjusted (e.g. via regulating means 206-1), or if the temperature or pressure in any of the components of the system requires adjustment.

System monitoring means may be located as required in any of the components of the GQCS 20, the heat recovery subsystem 18, the solid residue handling means 16, and the product gas handling subsystem 22, if such subsystems are present.

### Composition of Product Gas

As discussed previously, if the product gas is intended for use in the generation of electricity, then it is desirable to obtain products which can be used as fuel to power energy generators. In this case, the optimal energetics are measured by the efficiency with which energy may be generated using the gases produced.

The main components of the output gas as it leaves the reaction vessel 14 are carbon monoxide, carbon dioxide, hydrogen, and steam, with lesser amounts of nitrogen. Much smaller amounts of methane, acetylene and hydrogen sulfide may also be present. The proportion of carbon monoxide or carbon dioxide in the output gas depends on the amount of oxygen which is fed into the reaction vessel 14. For example, carbon monoxide is produced when the flow of oxygen is controlled so as to preclude the stoichiometric conversion of carbon to carbon dioxide, and the process is so operated to produce mainly carbon monoxide.

The composition of the product synthesis gas may be optimized for a specific application (e.g., gas turbines 24 and/or fuel cell application 26 for electricity generation) by adjusting the balance between, for example, applied plasma heat 15, oxygen and/or steam and/or carbon-rich process additives 38 (or via a secondary feedstock 39). Since addition of oxidant and/or steam process additives during the gasification process affects the conversion chemistry, it is desirable to provide means, such as monitoring means 202, for monitoring the syngas composition. The above-described inputs of the reactants are varied, e.g. via regulating means 206, to maintain the parameters of the synthesis gas within predetermined tolerances which are defined by the end use of the synthesis gas.

Monitoring of the product gas can be achieved using various monitoring means 202 such as a gas monitor and gas flow meter. The gas monitor may be used to determine the hydrogen, carbon monoxide and carbon dioxide content of the synthesis gas, the value of which is useable in various control steps, as illustratively depicted by the exemplary logic boxes 30 and 32 of FIG. 15. Composition of the product gas is generally measured after the gas has been cooled and after it has undergone a conditioning step to remove particulate matter.

The product gas can be sampled and analyzed using methods well known to the skilled technician. One method that can be used to determine the chemical composition of the product gas is through gas chromatography (GC) analysis. Sample points for these analyses can be located throughout the system. In one embodiment, the gas composition is measured using a Fourier Transform Infrared (FTIR) Analyser, which measures the infrared spectrum of the gas.

In one embodiment, the parameters of the product gas, such as temperature, flow rate and composition, may be monitored via monitoring means 202 located at the axial outlet vent 40 of the reaction vessel 14. In another embodiment, sampling ports may also be installed at any location in the product gas handling system. As discussed previously, regulating means 206 are provided to vary the inputs of the reactants to maintain the parameters of the product gas within predetermined tolerances as defined by the end use of the product gas.

An aspect of this invention may consist in determining whether too much or too little oxygen is being added during the gasification process by determining the composition of the outlet stream and adjusting the process accordingly. In a preferred embodiment, an analyzer, sensor or other such monitoring means 202 in the carbon monoxide stream detects the presence and concentration of carbon dioxide or other suitable reference oxygen rich material.

It will be apparent that other techniques may be used to determine whether mostly carbon monoxide is being produced. In one alternative, the ratio of carbon dioxide to carbon monoxide may be determined. In another alternative, a sensor may be provided to determine the amount of oxygen and the amount of carbon downstream of the plasma generator, calculating the proportion of carbon monoxide and carbon dioxide and then making process adjustments accordingly. In one embodiment, the values of CO and H₂ are measured and compared to target values or ranges. In another embodiment, the product gas heating value is measured and compared to target values or ranges.

The person of skill in the art will understand that these and other such product gas composition measurements, which may be carried throughout a given embodiment of the system 10 via the above or other such monitoring means 202, may be used to monitor and adjust, via regulating means 206, the ongoing process to maximize process outputs and efficiencies, and should thus not be limited by the examples listed above and provided by the illustrative system and control subsystem configurations depicted in the appended Figures.

### Temperature at Various Locations in System

In one embodiment of the invention, there is provided means, as in monitoring means 202, to monitor the temperature at sites located throughout the system 10, wherein such data are acquired on a continuous or intermittent basis. Monitoring means 202 for monitoring the temperature in the reaction vessel 14, for example, may be located on the outside wall of the reaction vessel 14, or inside the refractory at the top, middle and bottom of the reaction vessel 14.

Monitoring means 202 for monitoring the temperature of the product gas may be located at the product gas exit 40, as well as at various locations throughout the product gas conditioning system (e.g. within GQCS 20). A plurality of thermocouples can be used to monitor the temperature at critical points around the reaction vessel 14.

If a system for recovering the sensible heat produced by the gasification process is employed (such as a heat exchanger or similar technology), as in 18, a monitoring means 202 for monitoring the temperature at points in the heat recovery system (for example, at coolant fluid inlets and outlets) may also be incorporated. In one embodiment, a gas-to-air heat exchanger 48, a heat recovery steam generator (HRSG) 50 or both are used to recover heat from the hot gases produced by the gasification process. In embodiments employing heat exchangers, the temperature transmitters are located to measure, for example, the temperatures of the product gas at the heat exchanger inlets and outlets. Temperature transmitters are also provided to measure the temperature of the coolant after heating in the heat exchanger.

These temperature measurements can be used to ensure that the temperature of the product gas as it enters a respective heat exchanger does not exceed the ideal operating temperature of that device. For example, in one embodiment, if the design temperature for a gas-to-air heat exchanger 48 is 1050° C., a temperature transmitter on the inlet gas stream to the heat exchanger 48 can be used to control both coolant air flow rates through the system and plasma heat power in order to maintain the optimum product gas temperature. In addition, measurement of the product gas exit temperature may be useful to ensure that the optimum amount of sensible heat has been recovered from the product gas at all heat recovery stages.

A temperature transmitter installed on the air outlet stream to measure the temperature of the heated exchange-air ensures that the process is carried out under conditions that ensure the process air is heated to a temperature appropriate for use in the gasification process. In one embodiment, the coolant air outlet temperature is, for example, about 625° C., therefore a temperature transmitter installed on the air outlet stream will provide data that is used to determine whether adjustments to one or both of the air flow rates through the system and torch power in the plasma gasification vessel 14 (e.g. via regulating means 206-4 of FIGS. 14 and 15) should be made in order to maintain the optimum product gas input temperature, which in turn can be used to control the temperature of the coolant air.

According to one embodiment of the invention, the control strategy sets a fixed set point for the optimum coolant air output temperature, for example, about 600° C., as well as a fixed value for the HRSG gas exit temperature, for example, about 235° C. Therefore, according to this embodiment, when the product gas flow is reduced, the product gas temperature at the exit of the gas-to-air heat exchanger 48 gets cooler, resulting in decreased steam production because the HRSG gas exit temperature is also set to a fixed value.

The same concept applies when the airflow through the system is reduced. According to one embodiment of the present invention, the exit coolant air temperature remains fixed therefore the exit product gas temperature for the gas-to-air heat exchanger 48 is hotter, therefore producing more steam in the HRSG 50. However, when airflow through the system is reduced, product gas flow will consequently also reduce, so the increased inlet temperature to the HRSG 50 will only be momentarily high. For example, if airflow is reduced to 50%, the maximum inlet gas temperature that the HRSG 50 would momentarily see is approximately 800° C., which is within the temperature limits of the heat exchanger design.

In one embodiment of the invention, the monitoring means 202 for monitoring the temperature is provided by thermocouples installed at locations in the system 10 as required. Such temperature measurements can then be used, as described above, by the integrated control subsystem 200, as illustratively depicted by the exemplary logic box 34 of FIG. 15. The person skilled in the art will understand that other types of temperature measurements carried throughout a given embodiment of the system 10, via the above or other such monitoring means 202, may be used to monitor and adjust, via regulating means 206, the ongoing process to maximize process outputs and efficiencies, and should thus not be limited by the examples listed above and provided by the illustrative system and control means configurations depicted in the appended Figures.

### Pressure of System

In one embodiment of the invention, there is provided monitoring means 202 to monitor the pressure within the reaction vessel 14, as well as throughout the entire system 10, wherein such data are acquired on a continuous or intermittent basis. In a further embodiment, these pressure monitoring means 202 comprises pressure sensors such as pressure transducers located, for example, on a vertical vessel wall. Data relating to the pressure of the system 10 is used by the control subsystem 200 to determine, on a real time basis, whether adjustments to parameters such as plasma heat source power or the rate of addition of (e.g. via regulating means 206-1 and 206-4 of FIGS. 14 and 15) feedstock or process additives are required.

Variability in the amount of feedstock being gasified may lead to rapid gasification, resulting in significant changes in the pressure within the reaction vessel 14. For example, if an increased quantity of feedstock is introduced to the reaction vessel 14, it is likely that the pressure within the vessel 14 will increase sharply. It would be advantageous in such an instance to have monitoring means 202 to monitor the pressure on a continuous basis, thereby providing the data required to make adjustments in real time, via regulating means 206, to parameters (for example, the speed of the induction blower) to decrease the system pressure.

In a further embodiment, a continuous readout of differential pressures throughout the complete system 10 is provided, for example, via a number of pressure monitoring means 202. In this manner, the pressure drop across each individual component can be monitored to rapidly pinpoint developing problems during processing. The person of skill in the art will understand that the above and other such system pressure monitoring and control means can be used throughout the various embodiments of system 10 via the above or other such monitoring means 202, to monitor and adjust, via regulating means 206, the ongoing process to maximize process outputs and efficiencies, and should thus not be limited by the examples listed above and provided by the illustrative system and control means configurations depicted in the appended Figures.

### Rate of Gas Flow

In one embodiment of the invention, there is provided monitoring means 202 to monitor the rate of product gas flow at sites located throughout the system 10, wherein such data are acquired on a continuous or intermittent basis.

The rate of gas flow through the different components of the system will affect the residence time of the gas in a particular component. If the flow rate of the gas through the reforming region of the gasification reaction vessel 14 is too fast, there may not be enough time for the gaseous components to reach equilibrium, resulting in a non-optimum gasification process. The person of skill in the art will understand that these and other such gas flow monitoring and control means can be used throughout the various embodiments of system 10 via the above or other such monitoring means 202, to monitor and adjust, via regulating means 206, the ongoing process to maximize process outputs and efficiencies via an integrated control subsystem, such as the exemplary control subsystem 200 depicted in FIGS. 14 and 15.

### Computing Means

The integrated control subsystem 200 comprises means for controlling the reaction conditions and to manage the chemistry and energetics of the conversion of the carbonaceous feedstock to the output gas. In addition, the control subsystem 200 can determine and maintain operating conditions to maintain ideal, optimal or not, gasification reaction conditions. The determination of ideal operating conditions depends on the overall energetics of the process, including factors such as the composition of the carbonaceous feedstock and the specified composition of the product gases. The composition of the feedstock may be homogeneous or may fluctuate to certain degrees. When the composition of the feedstock varies, the certain system parameters may require continuous or regular adjustment, via regulating means 206, to maintain the ideal operating conditions.

The integrated control subsystem 200 can comprise a number of elements, each of which can be designed to perform a dedicated task, for example, control of the flow rate of one of the additives, control of the position or power output of one of the one or more plasma heat sources (e.g. 15, 44) of the gasification system, or control of the withdrawal of by-product. The control subsystem 200 can further comprise a processing system, as in processor(s) 208 of computing means 204. In one embodiment, the processing system can comprise a number of sub-processing systems.

In one embodiment, each sub-processing system can be configured to implement a reaction model that can mimic at least one aspect of the plasma reforming reactions. Each reaction model has its own model input and model output parameters and can be used to calculate changes of the model output parameters as an effect of changes to the model input parameters. Each reaction model can be used to perform an assessment to help predict changes to the operating conditions of the gasification system before affecting any of the control elements of the system. Note that each reaction model can only be used within a predetermined range of operating conditions where the simulated predictions sufficiently accurately mimic processes of the (real) plasma reforming system.

The processing system can further be configured with partial models or a full model of the reaction processes of the gasification system. Partial models, topped by the full model, can be of enormous complexity and can be used to predict changes to an ever increasing number of operating conditions or can be used to expand the range of operating conditions within which the model is sufficiently accurate or valid. The higher the level of abstraction and completeness of the description of the reaction processes, the more powerful the predictions of the processing system. Increasing complexity of the full model, however, can affect the utility of the model for predicting certain effects on the operating conditions of the gasification system. Their usefulness may be limited to predicting effects over short time periods or small parameter changes.

FIG. 28 provides an exemplary embodiment of such a system model, which may be used in conjunction with the integrated control subsystem 200 to define various operational parameters, and predicted results based thereon, for use as starting points in implementing the various processes of system 10. In one embodiment, these and other such models are used occasionally or regularly to reevaluate and/or update various system operating ranges and/or parameters of the system 10 on an ongoing basis. In one embodiment, the NRC HYSYS simulation platform is used and can consider as inputs, any combination of input chemical composition, thermo-chemical characteristics, moisture content, feed rate, process additve(s), etc. The model may also take provide various optional interactive process optimizations to consider, for example, site and coal type specifics, maximization of energy recovery, minimization of emissions, minimization of capital and costs, etc. Ultimately, based on the selected model options, the model may then provide, for example, various operational characteristics, achievable throughputs, system design characteristics, product gas characteristics, emission levels, recoverable energy, recoverable byproducts and optimum low cost designs.

Each reaction model can be implemented exclusively in hardware or in any combination of software and hardware. A reaction model, as illustrated in FIG. 28, can be described using any combination of an algorithm, a formula or a set of formulae which can be processed by the processing system. If the reaction model is exclusively implemented in hardware it can become an integral part of the processing system.

The processing system and any one of the sub-processing systems can comprise exclusively hardware or any combination of hardware and software. Any of the sub-processing systems can comprise any combination of none or more proportional (P), integral (I) or differential (D) controllers, for example, a P-controller, an I-controller, a PI-controller, a PD controller, a PID controller etc. It will be apparent to a person skilled in the art that the ideal choice of combinations of P, I, and D controllers depends on the dynamics and delay time of the part of the reaction process of the gasification system and the range of operating conditions that the combination is intended to control, and the dynamics and delay time of the combination controller.

Important aspects in the design of the combination controller can be short transient periods and little oscillation during transient times when adjusting a respective control variable or control parameter from an initial to a specified value. It will be apparent to a person skilled in the art that these combinations can be implemented in an analog hardwired form which can continuously monitor, via monitoring means 202, the value of a control variable or control parameter and compare it with a specified value to influence a respective control element to make an adequate adjustment, via regulating means 204, to reduce the difference between the observed and the specified value.

It will further be apparent to a person skilled in the art that the combinations can be implemented in a mixed digital hardware software environment. Relevant effects of the additionally discretionary sampling, data acquisition, and digital processing are well known to a person skilled in the art. P, I, D combination control can be implemented in feed forward and feedback control schemes.

### Corrective Control

In corrective, or feedback, control the value of a control parameter or control variable, monitored via an appropriate monitoring means 202, is compared to a specified value. A control signal is determined based on the deviation between the two values and provided to a control element in order to reduce the deviation. For example, when the output gas exceeds a predetermined H₂:CO ratio, a feedback control means, as in computing means 204, can determine an appropriate adjustment to one of the input variables, such as increasing the amount of additive oxygen to return the H₂:CO ratio to the specified value. The delay time to affect a change to a control parameter or control variable via an appropriate regulating means 206 is sometime called loop time. The loop time, for example, to adjust the power of the plasma heat source(s) 15, 44, the pressure in the system, the carbon-rich additive input rate, or the oxygen or steam flow rate, can amount to 30 to 60 seconds.

In one embodiment, the product gas composition is the specified value used for comparison in the feedback control scheme described above, whereby fixed values (or ranges of values) of the amount of CO and H₂ in the product gas are specified. In another embodiment, the specified value is a fixed value (or range of values) for the product gas heating value.

Feedback control is required for all control variables and control parameters which require direct monitoring or where a model prediction is satisfactorily. There are a number of control variables and control parameters of the gasification system 10 that lend themselves towards use in a feedback control scheme. Feedback schemes can be effectively implemented in aspects of the control subsystem 200 for those control variables or control parameters which can be directly sensed and controlled and whose control does not, for practical purposes, depend upon other control variables or control parameters.

### Feed Forward Control

Feed forward control processes input parameters to influence, without monitoring, control variables and control parameters. The gasification system can use feed forward control for a number of control parameter such as the amount of power which is supplied to one of the one or more plasma heat sources (15, 44). The power output of the arcs of the plasma heat sources (15, 44) can be controlled in a variety of different ways, for example, by pulse modulating the electrical current which is supplied to the torch to maintain the arc, varying the distance between the electrodes, limiting the torch current, or affecting the composition, orientation or position of the plasma.

The rate of supply of process additives that can be provided to the gasification reactor vessel 14 in a gaseous or liquid modification or in a pulverized form or which can be sprayed or otherwise injected via nozzles, for example can be controlled with certain control elements in a feed forward way. Effective control of an additive's temperature or pressure, however, may require monitoring and closed loop feed back control.

### Fuzzy Logic Control and Other Types of Control

Fuzzy logic control as well as other types of control can equally be used in feed forward and feedback control schemes. These types of control can substantially deviate from classical P, I, D combination control in the ways the plasma reforming reaction dynamics are modeled and simulated to predict how to change input variables or input parameters to affect a specified outcome. Fuzzy logic control usually only requires a vague or empirical description of the reaction dynamics (in general the system dynamics) or the operating conditions of the system. Aspects and implementation considerations of fuzzy logic and other types of control are well known to a person skilled in the art.

It will be understood that the foregoing embodiments of the invention are exemplary and can be varied in many ways. Such present or future variations are not to be regarded as a departure from the spirit and scope of the invention, and all such modifications as would be apparent to one skilled in the art are intended to be included within the scope of the following claims.

Gasification Reaction Vessels for Use with this System

With reference now to FIGS. 1 to 3, and to FIGS. 16 to 20, the present carbonaceous feedstock gasification system 10 comprises a gasification reactor vessel 14 having one or more processing zones and one or more plasma heat sources, as in 15. The gasification reaction vessel 14 also comprises means, as in 36, for inputting the feedstock into the reaction vessel, as well as means, as in 38 and/or 39, for adding one or more process additives, such as steam and/or oxygen/oxidant additives, and/or carbon-rich additives (the latter of which is optionally provided as a secondary feedstock 39) as required for maintaining the gasification processes at an optimal set point.

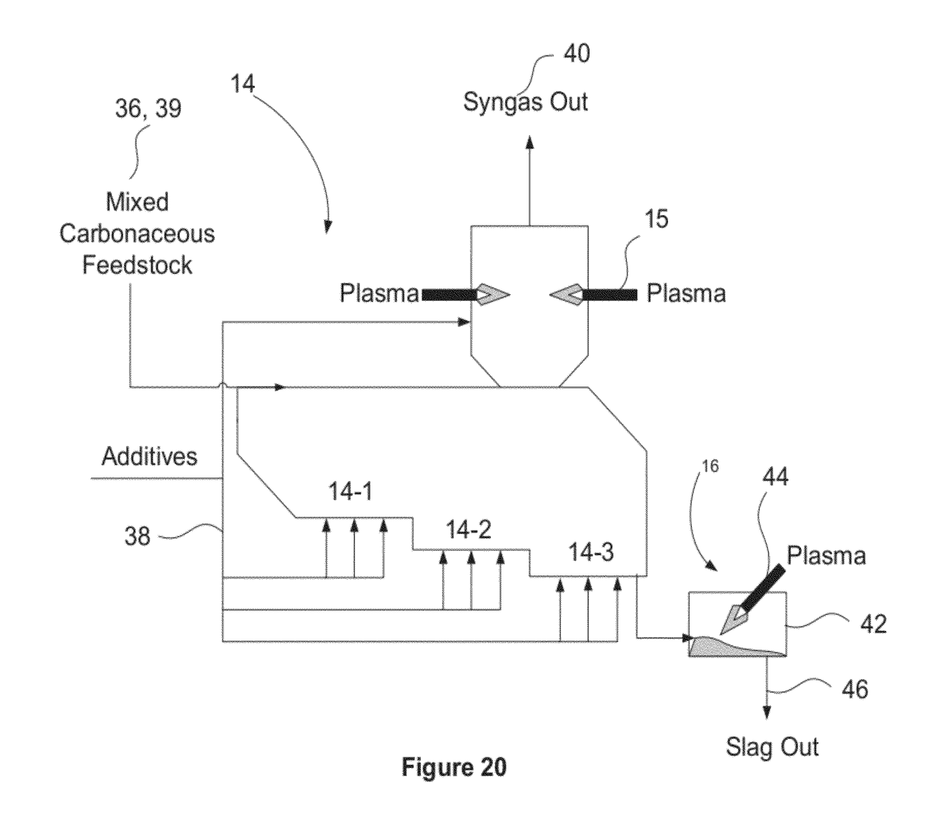

The gasification reaction vessel 14 can have a wide range of length-to-diameter ratios and can be oriented either vertically or horizontally. The gasification reaction vessel will have one or more gas outlet means 40, as well as means for removing solid residue (e.g., char, ash, slag or some combination thereof) 16, which is generally an outlet disposed somewhere along the bottom of the chamber (e.g. slag chamber 42) to enable the residue to be removed using gravity flow. In one embodiment, the gasification reaction vessel 14 will use physical transfer means to remove the solid residue from the bottom of the vessel. For example, a hot screw may be used to convey the ash by-product into a slag processing chamber 42. Means for processing and handling slag will be discussed in more detail later. Note that the slag may also be processed in the same chamber in which the gasification occurs (FIGS. 16 to 19), or in a separate chamber, as in slag chamber 42 of FIG. 20.

In one embodiment of the present invention, the one or more sources of plasma heat 15 assist in the feedstock-to-gas conversion process. In one embodiment of the present invention, the use of plasma heat sources 15, in conjunction with the input of steam and/or oxygen process additives 38, helps in controlling the gas composition. Plasma heat may also be used to ensure the complete conversion of the off gases produced by the gasification process into their constituent elements, allowing reformation of these constituent elements into the product gas having a specified composition. The product gas may then exit the gasification reaction vessel 14 via one or more output gas outlets 40.

The gasification of carbonaceous feedstocks (i.e., the complete conversion of the carbonaceous feedstocks to a syngas) takes place in the gasification reaction vessel 14, and can proceed at high or low temperature, or at high or low pressure. A number of reactions take place in the process of converting carbonaceous feedstocks to the syngas product. As the carbonaceous feedstock is gasified in the reaction vessel, the physical, chemical, and thermal processes required for the gasification may occur sequentially or simultaneously, depending on the reactor design.

In the gasification reaction vessel 14, the carbonaceous feedstock is subjected to heating, whereby the feedstock is dried to remove any residual moisture. As the temperature of the dried feedstock increases, pyrolysis takes place. During pyrolysis, volatile components are volatilized and the feedstock is thermally decomposed to release tars, phenols, and light volatile hydrocarbon gases while the coal is converted to char. Char comprises the residual solids consisting of organic and inorganic materials.

The resulting char may be further heated to ensure complete conversion to its gaseous constituents, leaving an ash by-product that is later converted to slag. In one embodiment, the gasification of carbonaceous feedstocks takes place in the presence of a controlled amount of oxygen, to minimize the amount of combustion that can take place.

The combined products of the drying, volatilization and char-to-ash conversion steps provide an intermediate offgas product. This intermediate offgas gas may be subjected to further heating, typically by one or more plasma heat sources and in the presence of a controlled amount of steam, to complete the conversion of the carbonaceous feedstocks to the syngas. This final step is also referred to as a reformation step.

The one or more plasma heat sources can be positioned to make all the reactions happen simultaneously, or can be positioned within the reaction vessel to make them happen sequentially. In either configuration, the temperature of the pyrolysis process is elevated due to inclusion of plasma heat sources in the reactor.

The gasification reaction is driven by heat, which can be fueled by adding electricity or fossil fuels (e.g., propane) to heat the reaction chamber or adding air as a reactant to drive the exothermic gasification reaction, which provides heat to the reaction. Some gasification processes also use indirect heating, avoiding combustion of the feed material in the gasification reactor and avoiding the dilution of the product gas with nitrogen and excess CO₂.

The design of some gasification reaction vessels 14 is such that the process for converting the feedstock to a syngas may take place in a one-stage process, i.e., where the gasification and reformation steps both take place generally in a single zone within the system. In such a case, the product gas exiting the gasification reaction vessel 14 will be a syngas product.

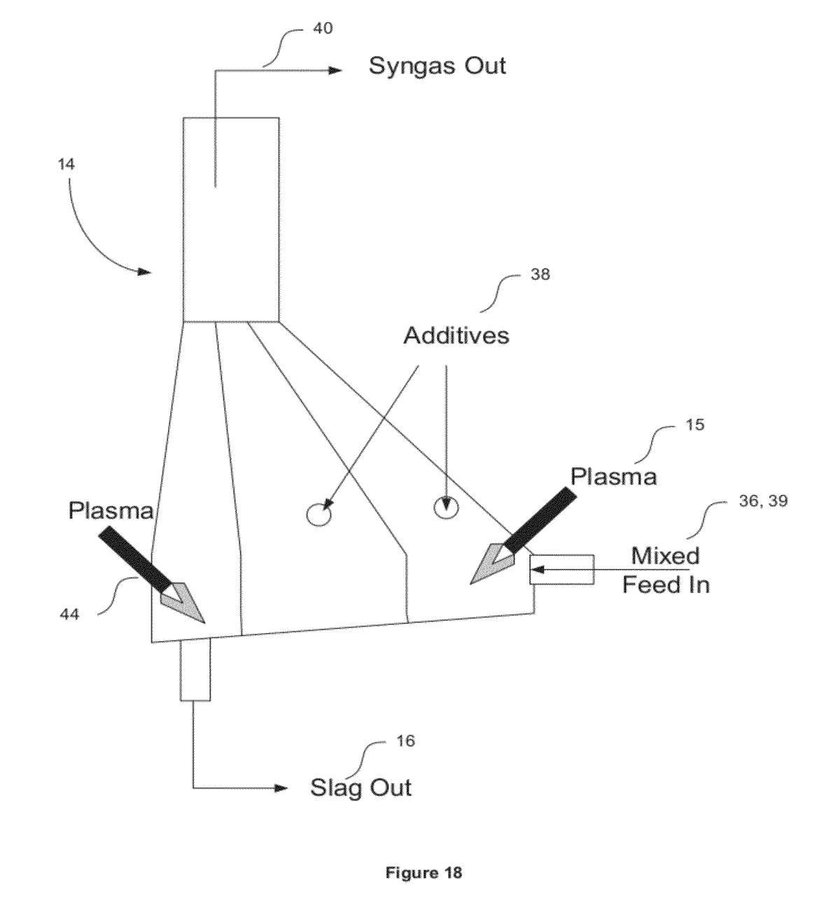

In one embodiment of the invention, it is conceived that the one stage process takes place within a single chambered reaction vessel 14, where the gasification and reformation steps both take place in the same chamber. For example, the reaction vessel embodiments depicted in FIGS. 16 to 19 could be interpreted to encompass single chamber, and optionally single zone (i.e., particularly the embodiments of FIGS. 16 and 18) reaction vessels wherein both the gasification and reformation processes occur within the main chamber of the vessel 14 and, in the case of a single zone vessel, in proximity of the one or more plasma heat sources 15.

In one embodiment of the invention, the conversion process takes place in two stages, first a feedstock to offgas stage, followed by a offgas to syngas (reformation) stage. In such a two stage process, it is conceived that at least two different zones (a first zone for the gasification step and a second zone for the reformation step) within a single chambered reaction vessel are required.

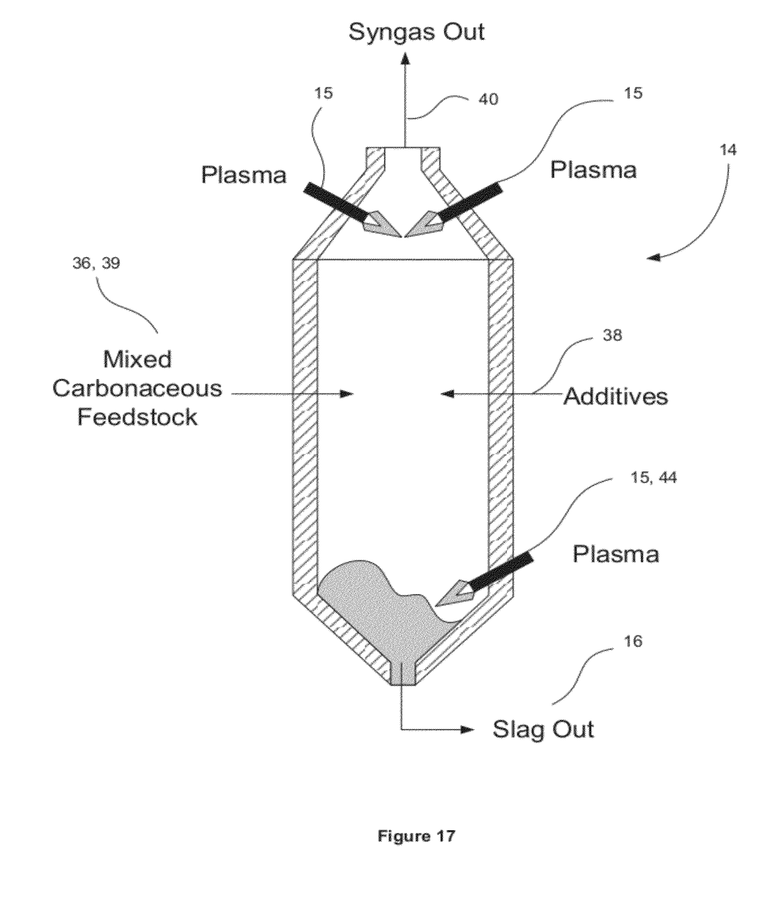

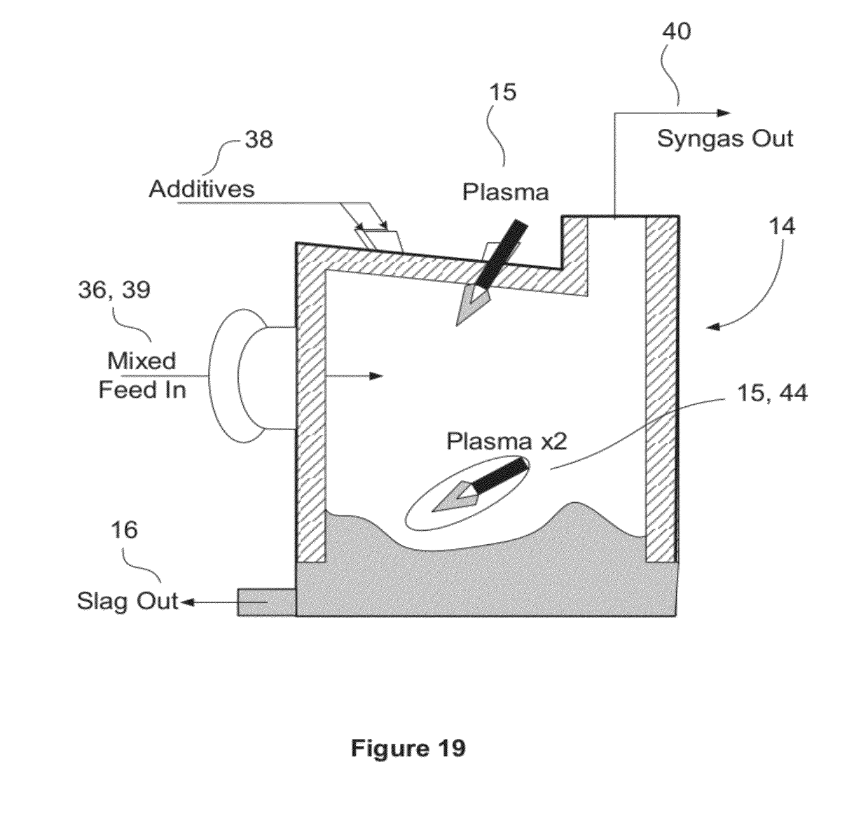

The design of other gasification reaction vessels 14 is such that the feedstock to syngas conversion process takes place in more than one zone, i.e., wherein the gasification and reformation steps are separated to some extent from each other and take place in different zones within the system. In these kinds of gasification reaction vessels, the process occurs either in more than one zone within one chamber (e.g. the embodiments of FIGS. 17 and 19 could be interpreted to represent multi-zone, single-chamber vessels), in separate chambers (e.g. the embodiment of FIG. 20) or some combination thereof, wherein the zones are in fluid communication with one another. Note that the slag may also be processed in a same chamber (FIGS. 16 to 19), or in a separate chamber, as in slag chamber 42 of FIG. 20.

In a multi-region gasification reaction vessel, a first, or primary, zone is used to heat the feedstock to dry the feedstock (if residual moisture is present), extract the volatile constituents of the feedstock, and optionally convert the resulting char to a gaseous product and ash, thereby producing an offgas product, while a second zone is used to apply plasma heat to assure the complete conversion of the offgas into the syngas product. Where two or more distinct zones are used for the gasification of the feedstock and the conversion of offgas to syngas, the product gas exiting the final region of the gasification reaction vessel is a syngas.

The gasification reaction vessel 14 of the present invention optionally comprises one or more process additive input means 38, which are provided for the addition of gases such as oxygen, air, oxygen-enriched air, steam or other gas useful for the gasification process, into the gasification reaction vessel 14. The process additive input means 38 may also provide means for the addition of a carbon-rich process additive into the gasification vessel, which may also be provided via a secondary feedstock input means 39 (FIGS. 16 to 20 define a mixed feedstock input means which illustratively combines the primary feedstock input means 36 and optional secondary feedstock input means 39). Thus, the process additive input means 38 can include air (or oxygen) input ports and/or steam input ports and/or carbon-rich material input ports, the latter of which is optionally provided via a secondary (or mixed) feedstock option 39. These ports are positioned within the reaction vessel for the optimal distribution of process additives throughout the vessel. The addition of process additives will be discussed in greater detail later.

In one embodiment, the carbon-rich additive/feedstock is added to the main or primary feedstock such that a mixed feedstock enters the gasification vessel 14 via the input means 36 (combined inputs 36 and 39). The person of skill in the art will understand that various input configurations may be considered to input a primary feedstock, an optional secondary feedstock (e.g., a carbon-rich additive) and a mixed feedstock (combined primary and secondary feedstocks/carbon-rich additive).

The carbon-rich additive (or secondary feedstock) may be any material that is a source of carbon that can be added to the feedstock undergoing gasification to increase the amount of carbon available for the gasification process. Supplementing the feedstock being gasified with a carbon-rich material helps ensure the formation of a product gas having a specified composition. Examples of carbon-rich additives that can be used in accordance with the present invention may include, but are not limited to, tires, plastics, or high-grade coal.

In one embodiment, the heat required to drive the gasification of the carbonaceous feedstock is provided by heated air. In such an embodiment, the gasification reaction vessel 14 comprises one or more heated air input means for the introduction of heated air to the gasification region. The heated air input means include exchange air inlets. These inlets are positioned within the reaction vessel to distribute the heated air throughout the reaction vessel 14 to initiate and drive the conversion of the feedstock to a gaseous product.

With reference to the exemplary embodiment of FIG. 25, the gasification reaction vessel 14 depicted therein comprises a horizontally oriented gasification chamber which is subdivided into three gasification zones (e.g. 14-1, 14-2, 14-3) which provide for the optimization of the extraction of gaseous molecules from carbonaceous feedstock by sequentially promoting, each in a respective zone, drying, volatilization and char-to-ash conversion (or carbon conversion). This is accomplished by allowing drying of the feedstock to occur at a certain temperature range in a first zone 14-1 prior to moving the material to a second zone 14-2, where volatilization occurs at another temperature range, prior to moving the material to a third zone 14-3 where char-to-ash conversions (or carbon conversion) occurs at another temperature range.

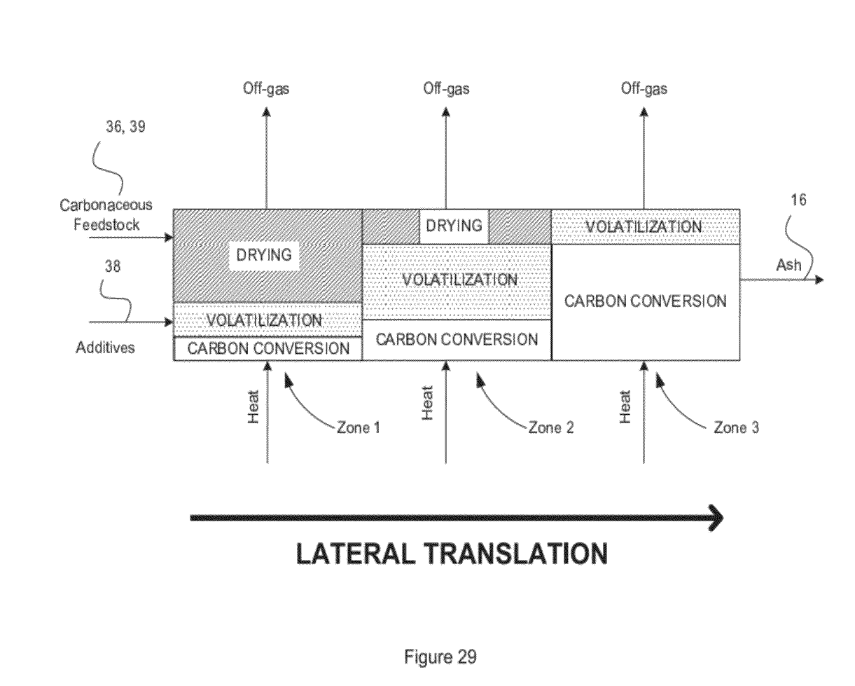

The three zones are schematically represented if FIG. 29, wherein exemplary reaction ratios are illustrated as progressing from a first zone where the drying process is most prominent over the volatilization and carbon conversion processes; a second zone wherein the volatilization process takes over; and a third zone where the material is practically completely dry, and the carbon conversion process takes over.

The horizontal expansion of the gasification process allows for the optimization of the gasification process by regionally promoting one or more of the stages of the gasification process in response to the characteristics of the feedstock material at that particular location in the reaction vessel 14 of FIG. 20. It would be apparent to a worker skilled in the art that this reaction vessel 14 could therefore be segregated into two, three, four or more steps depending on the characteristics of the feedstock used. The discussion below describes segregating the reaction vessel into three steps. The exemplary embodiment provided by vessel 14 of FIG. 20, however, is not technically restricted to three steps.

In one embodiment, means are provided to move the material through the gasification reactor in order to facilitate specific stages of the gasification process (drying, volatilization, char-to-ash conversion). To enable control of the gasification process, means to control the material movement through the gasification reactor is also provided. This lateral movement of material through the reaction vessel can be achieved via the use of one or more lateral transfer units. This is achieved with the lateral transfer means by varying the movement speed, the distance each lateral transfer means moves and the sequence in which the plurality of lateral transfer means are moved in relation to each other. The one or more lateral transfer means can act in coordinated manner or individual lateral transfer means can act independently. In order to optimize control of the material flow rate and pile height the individual lateral transfer means can be moved individually, at varying speeds, at varying movement distances, at varying frequency of movement. The lateral transfer means must be able to effectively operate in the harsh conditions of the reaction vessel and in particular must be able to operate at high temperatures.

The feedstock is delivered into the first step 14-1. The normal temperature range for the first step (as measured at the bottom of the material pile) lies between 300 and 900° C. The major process here is that of drying with some volatilization and some carbon-to-ash conversion. These processes occur mainly between 25 and 400° C. As the amount of drying tapers off, the temperature rises and a lateral transfer means moves the material towards the second step 14-2 as dictated by the integrated control system 200, or a subsystem thereof.

In the second step 14-2, the material is treated by process additives and has a bottom temperature range between 400 and 950° C. The main process occurring here is that of volatilization with the remainder of the drying operation as well as a substantial amount of carbon conversion (char combustion). These processes occur mainly between 400 and 700° C. As the amount of volatilization tapers off, the temperature rises and the lateral transfer means moves the material towards the third step 14-3.

The third step temperature range lies between 600 and 1000° C. The major process in the third step 14-3 is that of carbon conversion with the remainder of volatilization. By this time most of the moisture has been removed from the material, and the normal temperature range is between 600 and 1000° C. As the amount of char conversion tapers off, the temperature increases and the lateral transfer means moves the solid residue (mostly ash) through an outlet in the chamber to the solid residue handling system 16 for further processing.

The lateral transfer means comprise lateral transfer units, motor means and actuators. The individual lateral transfer units comprise a moving element and a guiding element. In one embodiment, the moving element is a shelf or platform in which material is predominantly moved through the gasification reactor by sitting on top of the shelf/platform. A fraction of material may also be pushed by the leading edge of the movable shelf/platform. The guide element can include one or more guide channels located in the side walls of the reaction vessel, guide tracks or rails, a guide trough or guide chains.

The guide engagement members can include one or more wheels or rollers sized to movably engage the guide element. In one embodiment of the invention, the guide engagement member is a sliding member comprising a shoe adapted to slide along the length of the guide track. Optionally, the shoe further comprises at least one replaceable wear pad.

Power to propel lateral transfer means is provided by a motor means including a motor and drive system. In one embodiment the motor means is an electric variable speed motor which drives a motor output shaft in the forward or reverse directions. Optionally, a slip clutch could be provided between the motor and the motor output shaft. The motor may further comprise a gearbox.

Movement of the lateral transfer means can be effected by a hydraulic system, chain and sprocket drive, or a rack and pinion drive. These methods of translating the motor rotary motion into linear motion have the advantage that they can be applied in a synchronized manner at each side of a unit to assist in keeping the unit aligned and thus minimizing the possibility of the mechanism jamming.

In one embodiment, the sidewalls of the chamber slope inwards towards the bottom to achieve a small enough width for good air penetration while still having the required volume of material. The slope angle is made steep enough to assure that the material will drop towards the bottom of the chamber during processing.

In one embodiment, the gasification chamber 14 is a horizontal vessel with its cross-section optionally including a semi-circular dome or arched roof and a tapered lower section.

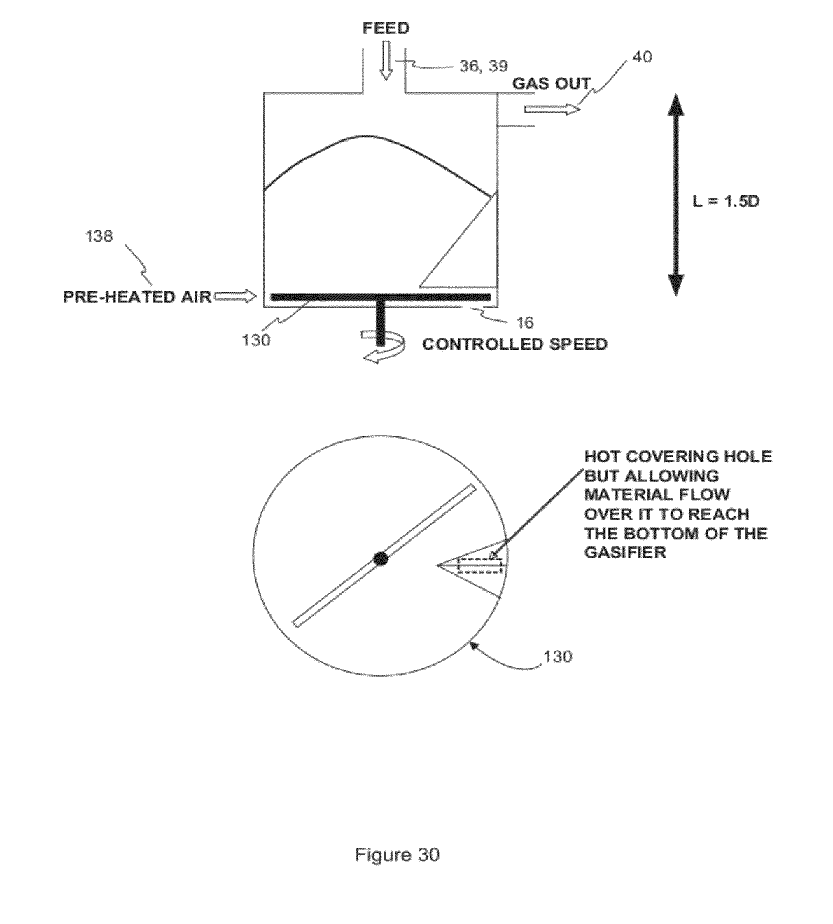

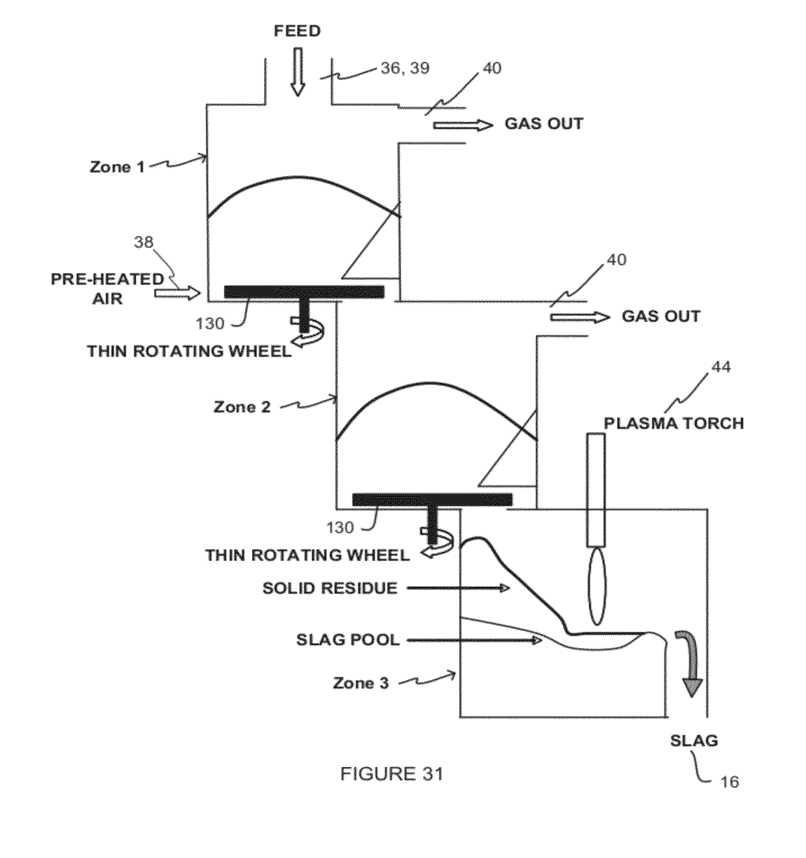

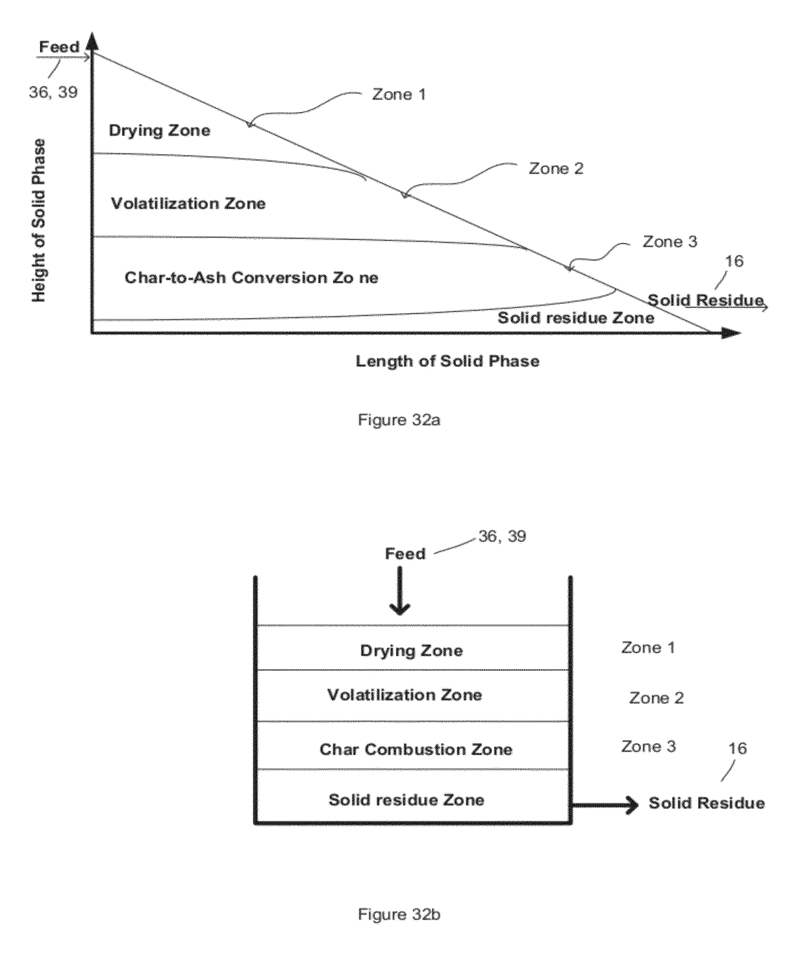

With reference to FIGS. 30 to 32, the drying, volatilization and char-to-ash conversion steps of the gasification process described above can also be carried out in a vertically oriented gasification reaction vessel 14 (as schematically depicted in FIGS. 32A and 32B). In such an embodiment, the gasification reaction vessel 14 comprises one or more gasification chambers, at least one of which is vertically oriented and comprises a controllable solids removal means, as in rotating wheel 130, allowing for the optimization of the extraction of gaseous molecules from carbonaceous feedstock(s) (e.g. single chamber—FIG. 30, multiple chamber—FIG. 31).

As shown generally in FIGS. 30 and 31, the vertically oriented gasification vessel 14 comprises a feedstock input 36, 39 proximal to the top of a gasification chamber, one or more air inlets 38 proximal to the bottom of the chamber, a gas outlet 40, a solid residue outlet 16 and a controllable solids removal means 130 at the base of the chamber for conveying solid residue out of the chamber. The gasification chamber is typically heated by one or more heating means. Thus, the material in the vertically oriented gasification reaction vessel essentially passes through a series of zones each of which experiences a temperature range that promotes a certain stage of the gasification process.

As the material in the chamber is moved vertically from the upper feedstock input area down towards the solid residue outlet end through the action of the solids removal means 130 it goes through different degrees of drying, volatization and char-to-ash conversion. This is accomplished by the formation of a countercurrent between controlled movement of the feedstock material down through the chamber and the upward movement of the preheated air being fed into the chamber from the base. As such, the temperature will be lowest at the top of the vertically oriented material, which allows drying to occur to a significant degree prior to the material moving downwards to another zone where the temperature will be higher allowing for volatilization. Finally the material will move downwards to another zone where the temperatures is high enough to allow a significant amount of char-to-ash conversion to occur. Once the char-to-ash conversion is essentially complete, the solids are removed from the gasification chamber by the solids removal means.

In one embodiment, the gasification reaction vessel comprises more than one chamber. In another embodiment, each of the temperature zones is located in a different chamber.

In order to ensure that the design objectives are achieved, the solid residue outlet is small in terms of vertical dimension. The configuration in which the solids exit the chamber is dependent on the design and function of the subsequent chamber and can be readily determined by one skilled in the art.

The gasification chamber is a refractory lined chamber with an internal volume sized to accommodate the appropriate amount of material for the required solids residence time. In one embodiment of the present invention, the gasification chamber is tubular or circular. In another embodiment, a lower portion of the inner wall is sloped inwardly above the solid residue outlet. In a further embodiment, the height of the gasification chamber is between about 1 and 3 times its diameter. In another embodiment, the height of the gasification chamber is between about 1 and 2 times its diameter. In a further embodiment, the height of the gasification chamber is about 1.5 times its diameter.

During processing, feedstock is introduced into the reaction vessel at one end through the feedstock input and moves from the feed end through the various zones in the gasification reaction vessel towards the solid residue output end. As the feed material progresses through the vessel it losses its mass and volume as its volatile fraction is volatilized to form off-gas and the resulting char is reacted to form additional off-gas and ash. In one embodiment, the ash is subsequently heated to form slag. During processing, air (oxygen) is introduced through one or more air inlets 38 located at the sides of the reaction vessel 14 proximal to the base.

Means are provided to move the material through the gasification reactor in order to facilitate specific stages of the gasification process (drying, volatilization, char-to-ash conversion). To enable control of the gasification process, means to control the material movement through the gasification reactor is also provided. The rate of vertical movement of material through gasification reactor is regulated via the use of a controllable solids removal means (e.g. wheel 130).

The solid residue removal means 130 can be one of a variety of devices known in the art.

Examples include, but are not limited to, screws, pusher rams, horizontal rotating paddles, horizontal rotating arms, horizontal rotating wheels.

In one embodiment, the solids removal device is a rotating paddle with thin spokes which moves the solid residue out of the chamber. In another embodiment, the solids removal device is a set of screws that move the solid residue out of the chamber. In this case the bottom portion of the sides is made slanting so that the solid residue may be directed towards the screws. In yet another embodiment, the solids removal device is a single thin ram which moves the solid residue out of the chamber. In this case the bottom portion of the side opposite to the ram is made slanting so that the solid residue may be directed towards the ram leaving space for the exit hole.

In yet another embodiment of the invention, the solids removal device comprises a moving element and a guiding element. Suitable moving elements include, but are not limited to, a shelf/platform, pusher ram, plow, screw element or a belt. The guide element can include one or more guide channels located in the bottom wall of the gasification chamber, guide tracks or rails, guide trough or guide chains. The guide engagement members can include one or more wheels or rollers sized to movably engage the guide element. In one embodiment of the invention, the guide engagement member is a sliding member comprising a shoe adapted to slide along the length of the guide track. Optionally, the shoe further comprises at least one replaceable wear pad.

The gasification reaction vessel 14 can be based on one of a number of standard reactors known in the art. Examples of reaction vessels known in the art include, but are not limited to entrained flow reactor vessels, moving bed reactors, fluidized bed reactors, and rotary kiln reactors, each of which is adapted to accept the feedstock(s) in the form of solids, particulates, slurry, liquids, gases or any combination thereof, through a feedstock input means 36, 39. The feedstock(s) is introduced through one or more inlets, which are disposed to provide optimum exposure to heating for complete and efficient conversion of the feedstock(s) to the product gas.

Also, in accordance with one embodiment of the present invention, the gasification reaction vessel wall is lined with refractory material. The refractory material can be one, or a combination of, conventional refractory materials known in the art which are suitable for use in a vessel for a high temperature (e.g., a temperature of about 1100° C. to 1400° C.) non-pressurized reaction. Examples of such refractory materials include, but are not limited to, high temperature fired ceramics (such as aluminum oxide, aluminum nitride, aluminum silicate, boron nitride, zirconium phosphate), glass ceramics, chromia refractories and high alumina refractories containing alumina, titania, and/or chromia.

As is understood by those of skill in the art, different regions of the gasification reaction vessel may be lined with different refractory materials, according to temperature and corrosion requirements of a particular region. For example, if slagging is present, it may be advantageous to use a non-wetting refractory material.

With reference still to FIGS. 16 to 20, 29 to 31, the person of skill in the art will understand that by moving the one or more plasma heat source 15, by adding other plasma heat sources, other sources of heat, and the like, the illustrated vessels 14 may be operated as single or multiple zone reaction vessels 14 without departing from the general scope and spirit of the present disclosure. Furthermore, it will be understood that the present coal gasification system 10 with integrated control subsystem 200 may be implemented with any of the above or other such gasification vessel configurations. In fact, by monitoring one or more direct or indirect process parameter relevant to the gasification and/or reformation processes implemented within a given type of reaction vessel, whether these processes take place in a single zone or multiple zones within a single or multiple chamber, the control means 200 of the present system 10 may be used, via monitoring means 202, to monitor and adjust the ongoing processes to maximize, via regulating means 206, process outputs and efficiencies.

The person of skill in the art will further understand that, although the above description provides a number of exemplary reaction vessel types, configurations, and materials to be used therefor, other reaction vessel types, configurations and/or materials may be used without departing from the general scope and nature of the present disclosure.

### Plasma Heating Means

Referring now to FIGS. 1 to 3 and 16 to 20, 29 to 31 the system of the present invention employs one or more plasma heating means, as in 15, to ensure complete conversion of the offgas produced by the gasification process to a product gas having a specified composition. Plasma heating means 15 may also be optionally provided to heat the carbonaceous feedstock to drive the initial gasification process.

In one embodiment of the present invention, the one or more plasma heat sources 15 will be positioned to optimize the offgas conversion to a specified product gas. The position of the one or more plasma heat sources is selected according to the design of the gasification system, for example, according to whether the system employs a one stage or two stage gasification process. For instance, in one embodiment that employs a two stage gasification process, the plasma heat source may be disposed in a position relative to the offgas inlet, and pointed in the direction of the offgas inlet. In another embodiment that employs a one stage gasification process, the one or more plasma heat sources 15 may extend towards the core of the gasification reaction vessel. In all cases, the position of the plasma heat sources is selected according to the requirements of the system, and for optimal conversion of the offgas to the specified product gas.

Where more than one plasma heat source is used, the position of the heat sources is also selected to ensure that there is no conflict between two or more heat sources, for example, that no heat source is subjected to direct heat from another or that there is no arcing from one plasma heat source to another.

In addition, the location of the one or more plasma heat sources is selected to avoid impacting the wall of the reaction vessel with the plasma plume, thereby avoiding the formation of “hot spots”.

A variety of commercially available plasma heat sources which can develop suitably high temperatures for sustained periods at the point of application can be utilized in the system. In general, such plasma heat sources are available in sizes from about 100 kW to over 6 MW in output power. The plasma heat source, or torch, can employ one, or a combination, of suitable working gases. Examples of suitable working gases include, but are not limited to, air, argon, helium, neon, hydrogen, methane, ammonia, carbon monoxide, oxygen, nitrogen, and carbon dioxide. In one embodiment of the present invention, the plasma heating means is continuously operating so as to produce a temperature in excess of about 900 to about 1100° C. as required for converting the offgas to the syngas product.

In this respect, a number of alternative plasma torch technologies are suitable for use in the present system. For example, it is understood that inductively coupled plasma torches (ICP) may be employed. It is also understood that transferred arc and non-transferred arc torches (both AC and DC), using appropriately selected electrode materials, may also be employed. For example, electrode materials may be selected from, but are not limited to, copper and its alloys, stainless steel and tungsten. Graphite torches may also be used. Selection of an appropriate plasma heating means is within the ordinary skills of a worker in the art.

In one embodiment, the plasma heat sources 15 are located adjacent to one or more air/oxygen and/or steam input ports 38 such that the air/oxygen and/or steam additives are injected into the path of the plasma discharge of the plasma heat source 15.

In a further embodiment, the plasma heat sources 15 may be movable, fixed or any combination thereof.

The process of the present invention uses the controllability of plasma heat to drive the conversion process and ensure that the gas flow and gas composition from the converter remain within predefined tight tolerances. Control of the plasma heat also assists in the efficient production of the product gases, irrespective of the composition of different carbonaceous feedstock sources or any natural variability in sources of the same type of feedstock.

In one embodiment, the control subsystem 200 comprises regulating means 206 to adjust the power of the plasma heat sources 15 to manage the net overall energetics of the reaction and maintain an optimal set point. In order to manage the energetics of the reaction, the power to the plasma heat source 15 may be adjusted to maintain a constant gasification system temperature despite any fluctuations in the composition of the feedstock and corresponding rates of feed of steam, air/oxidant and carbon-rich process additives.

The control subsystem 200 controls the power rating of the plasma heat source 15 relative to the measured parameters such as the rate at which the carbonaceous feedstock and process additives are introduced into the gasification reaction vessel, as well as the temperature of the system as determined by temperature sensors, and other such monitoring means 202, located at strategic locations throughout the system 10. The power rating of the plasma heat source 15 must be sufficient to compensate, for example, for loss of heat in the gasification reaction vessel 14 and to process the added feedstock efficiently.

For example, when the temperature of the reaction vessel 14 is too high, the control subsystem 200 may command a drop in the power rating of the plasma heat source 15 (e.g. via regulating means 206-4 of FIGS. 14 and 15); conversely, when the temperature of the melt is too low, the control subsystem 200 may command an increase in the power rating of the plasma heat source 15.

In one embodiment of the invention, the control subsystem 200 comprises regulating means 206 to control the position of the torch to ensure the maintenance of the optimal high temperature processing zone as well as to induce advantageous gas flow patterns around the entire reaction vessel 14.

One or more plasma heat sources, as in 44, are also optionally provided to ensure complete processing of the solid residue of the gasification process, as will be discussed later.

### Feedstock Input Means

Still referring to FIGS. 1 to 3 and 16 to 20, 29 to 31, the invention includes means, as in input means 36, for introducing the carbonaceous feedstock to the gasification reaction vessel 14. The input means 36 are located to ensure that the feedstock is deposited at an appropriate location in the reaction vessel 14 for optimum exposure to the gasifying heat source.

In one embodiment, the input means 36 is also provided with regulating means 206 for adjusting the feed rate to ensure that the feedstock is fed into the reaction vessel 14 at an optimum rate for maintaining the gasification reaction at an optimum set point.

In one embodiment, the control subsystem 200 comprises regulating means 206 to adjust the rate of feedstock input to manage the net overall energetics of the reaction. For example, the rate of feedstock addition to the gasification reaction vessel 14 can be adjusted to facilitate the efficient conversion of the feedstock into the product gases. The rate of feedstock addition is selected to manage the overall energetics of the system according to the design specifications of the system 10, while maintaining the reaction set point within certain tolerances.

The selection of the input means 36 is made according to the requirements for feed dispersion, the operating pressure and the feedstock particle size. Input means 36 may include, for example, a screw auger, a pneumatic transport system, a plunger system, a ram system, a rotary valve system, or a top gravity feed system.

In one embodiment, municipal waste can be used as a feedstock for the gasification process. Municipal waste may be provided in solid or liquid form. For the gasification of solid wastes, the waste is introduced to the reaction vessel 14 through a solid waste inlet feed port. The reaction vessel may also be designed to optionally include liquid waste feed inlet ports for the processing of liquid waste. Feeding of the waste into the reaction vessel 14 is commenced through the solid waste port and/or liquid waste ports (depending on the type of waste being processed).

A conditioning process for preparing the feedstock prior to introduction to the reaction vessel 14 may also be utilized. In one embodiment of the invention, the feedstock, depending on its nature and to increase efficiencies and achieve a specified product gas composition and energy outputs, can be pretreated, for example, to reduce its volume overall or increase its surface area to volume ratio by shredding, pulverizing, shearing, etc. In another embodiment, the feedstock may also undergo a pre-drying step to remove any residual moisture as required.

### Process Additive Input Means

Still referring to FIGS. 1 to 3 and 16 to 20, 29 to 31 process additives may optionally be added to the reaction vessel 14 (e.g. via process additive ports, as in 38) to facilitate efficient conversion of the carbonaceous feedstock into product gases. The type and quantity of the process additives are very carefully selected to optimize the carbonaceous feedstock conversion while maintaining adherence to regulatory authority emission limits and minimizing operating costs. Steam input ensures sufficient free oxygen and hydrogen to maximize the conversion of decomposed elements of the input waste into fuel gas and/or non-hazardous compounds. Air/oxidant input assists in processing chemistry balancing to maximize carbon conversion to a fuel gas (minimize free carbon) and to maintain the optimum processing temperatures while minimizing the relatively high cost plasma arc input heat. Carbon-rich additives (which may also be provided via secondary feedstock input means 39) may also be added to supplement the carbon content of the feedstock undergoing gasification. The quantity of each additive is established and very rigidly controlled as identified by the outputs for the waste being processed. The amount of oxidant injection is very carefully established to ensure a maximum trade-off for relatively high cost plasma arc input heat while ensuring the overall process does not approach any of the undesirable process characteristics associated with combustion, and while meeting and bettering the emission standards of the local area.

For those embodiments having the production of electrical energy as an objective, it is advantageous to produce gases having a high fuel value. The production of high quality fuel gases can be achieved by controlling reaction conditions, for example, by controlling the amount of process additives that are added at various steps in the conversion process.

The gasification reaction vessel 14, therefore, can include a plurality of process additive input ports 38, which may be provided for the addition of gases such as oxygen, air, oxygen-enriched air, steam or other gas useful for the gasification process. The process additive input means 38 can include air input ports and steam input ports. These ports are positioned within the reaction vessel 14 for the optimal distribution of process additives through the reaction vessel 14. The steam input ports can be strategically located to direct steam into the high temperature processing zone and into the product gas mass prior to its exit from the reaction vessel. The air/oxidant input ports can be strategically located in and around the reaction vessel to ensure fill coverage of process additives into the processing zone.

The process additive input ports 38 may also include input ports for the addition of carbon-rich materials, which may also be added via secondary feedstock input means 39. Feedstocks useful for the gasification process of the present invention can conceivably be any carbonaceous materials, and as such, may be inherently highly variable in their carbon content. In one embodiment of the invention, the system provides a means, as in 38 and/or 39, for the addition of a carbon-rich feedstock to supplement the carbon content of the feedstock undergoing gasification. The provision of a feedstock having a high carbon content increases the carbon balance in the product gases.

In one embodiment, there is also provided means for adding a carbon-rich material to the gasification reaction vessel 14. The carbon-rich material may be added by premixing with the feedstock before addition to the reaction vessel 14 (mixed feedstock input), or it may be added through a dedicated carbon-rich additive port, as in 38 and/or 39.

In one embodiment, the control subsystem 200 comprises means to control the addition of a carbon-rich feedstock to manage the net overall energetics of the reaction to maintain an optimal reaction set point within certain tolerances (e.g. via regulating means 206-1 of FIGS. 14 and 15).

In one embodiment, the control subsystem 200 comprises regulating means 206 to adjust the reactants to manage the net overall energetics of the reaction. For example, process additives may be added to the reaction vessel 14 to facilitate the efficient conversion of the feedstock into product gases. The type and quantity of the process additives are very carefully selected to manage the overall energetics of the system according to the design specifications of the system, while maintaining the reaction set point within certain tolerances. In another embodiment of the invention, the control subsystem 200 comprises regulating means 206 to control the addition of process additives to maintain an optimal reaction set point. In another embodiment of the control subsystem 200, regulating means 206 are provided to control the addition of two or more process additives to maintain the reaction set point. In yet another embodiment, regulating means 206 are provided to control the addition of three or more process additives to maintain the reaction set point.

In those embodiments comprising a one stage process, i.e., where the gasification and reformation steps both take place in a single chamber gasification reaction vessel 14, it is advantageous to strategically locate additive input ports, as in 38 and/or 39, in and around the gasification reaction vessel 14 to ensure full coverage of process additives into the processing zone. In those embodiments wherein the process takes place in two stages, i.e., the gasification and reformation take place in discrete regions within the system, it may be advantageous to locate certain additive ports (for example, steam inputs) proximal to the region where reformation by the plasma torch, or other such plasma heat source 15, takes place.

In a further embodiment, the control subsystem 200 comprises regulating means 206 for adjusting the additive inputs based on data obtained from monitoring and analyzing the composition of the product gas, via various monitoring means 202 and computing means 204 whereby these data are used to estimate the composition of the feedstock. The product gas composition data may be obtained on a continuous basis, thereby allowing the adjustments to additive inputs such as air, steam and carbon-rich additives to be made on a real-time basis (e.g. via regulating means 206-1, 206-2 and 206-3 of FIGS. 14 and 15). The product gas composition data may also be obtained on a intermittent basis.

The control subsystem 200 of the present invention, therefore, includes a means, as in regulating means 206 for introducing the additives into the system when the concentration of certain product gases is not at an optimal level, as monitored by various monitoring means 202, according to predetermined target levels. For example, in the event that a gas sensor detects too much carbon dioxide, the control subsystem 200 may reduce the delivery of oxidant into the converter to reduce the production of carbon dioxide (e.g. via regulating means 206-3 exemplified in FIGS. 15 and 16).

In one embodiment of the invention, the process is adjusted to produce mostly carbon monoxide, rather than carbon dioxide. In order to expedite the production of carbon monoxide in such an embodiment, the system will include a sensor, analyzer or other such monitoring means 202 for determining the amount of oxygen in the gaseous output stream. If the correct amount of oxygen from steam or air/oxidant inputs is used in the gasification process, the product gas will be mainly carbon monoxide. If there is too little oxygen, a considerable amount of elemental carbon or carbon black may form which will ultimately plug up equipment downstream from the reaction vessel 14. If there is too much oxygen in the system, too much carbon dioxide will be produced which has essentially no value, which is undesirable if the objective of the process is to produce a fuel gas. In response to too much carbon dioxide in the system, any steam or air/oxidant being injected is reduced or eliminated by an appropriate signal from the control subsystem 200 (e.g. via regulating means 206-2 and/or 206-3).

The conversion of a carbonaceous feedstock into fuel gas within the gasification reaction vessel 14 is an endothermic reaction, i.e., energy needs to be provided to the reactants to enable them to reform into the specified fuel gas product. In one embodiment of the invention, a proportion of the energy required for the gasification process is provided by the oxidation of a portion of the initial gaseous products or carbonaceous feedstock within the reaction vessel 14.

Introduction of an oxidant into the reaction vessel 14 creates partial oxidation conditions within the reaction vessel 14. In partial oxidation, the carbon in the coal reacts with a less than the stoichiometric amount of oxygen required to achieve complete oxidation. With the limited amount of oxygen available, solid carbon is therefore converted into carbon monoxide and small amounts of carbon dioxide, thereby providing carbon in a gaseous form.

Such oxidation also liberates thermal energy, thereby reducing the amount of energy that needs to be introduced into the gasification reaction vessel by the plasma heat. In turn, this increased thermal energy reduces the amount of electrical power that is consumed by the plasma heat source 15 to produce the specified reaction conditions within the reaction vessel 14. Thus, a greater proportion of the electricity produced by converting the fuel gas to electrical power in an electric power generating device (e.g. fuel cell application 26, gas turbine 24, etc.) can be provided to a user or exported as electrical power, because the plasma heat source requires less electricity from such an electric power generating device in a system which employs the addition of an oxidant.

The use of oxidant inputs as a process additive therefore assists in maximizing the conversion of carbon to a fuel gas and to maintain the optimum processing temperatures as required while minimizing the relatively high cost plasma arc input heat. The amount of oxidant injection is very carefully established to ensure maximum removal of carbon in gaseous form (CO and CO₂). Simultaneously, because the gasification of carbon reactions (combination with oxygen) are exothermic, substantial quantities of heat are produced. This minimizes the need for relatively high cost plasma arc input heat while ensuring the overall process does not approach any of the undesirable process characteristics associated with combustion. In one embodiment of the invention, the oxidant is air.

Although less fuel gas will be produced within the reaction vessel when partial oxidizing conditions exist (because some of the fuel gas or feedstock is oxidized to liberate thermal energy, and thus, less fuel gas is available to an electric power generating device), the reduction in electrical consumption by the plasma heat source(s) 15, 44 offsets a possible loss in electrical energy production. In one embodiment of the invention, the control subsystem 200 comprises means to adjust the addition of process additives to maintain an optimal reaction set point (e.g. via regulating means 206-2 and/or 206-3).

In one embodiment of the invention, the oxidant additive is selected from air, oxygen, oxygen-enriched air, steam or carbon dioxide. In those embodiments using carbon dioxide as an oxidizing process additive, the carbon dioxide may be recovered from the product gases and recycled into the process additive stream.

The selection of appropriate oxidizing additive is made according to the economic objectives of the conversion process. For example, if the economic objective is the generation of electricity, the oxidizing additive will be selected to provide the optimal output gas composition for a given energy generating technology. For those systems which employ a gas engine to generate energy from the product gases, a higher proportion of nitrogen may be acceptable in the product gas composition. In such systems, air will be an acceptable oxidant additive. For those systems, however, which employ a gas turbine 24 to generate energy, the product gases must undergo compression before use. In such embodiments, a higher proportion of nitrogen in the product gases will lead to an increased energetic cost associated with compressing the product gas, a proportion of which does not contribute to the production of energy. Therefore, in certain embodiments, it is advantageous to use an oxidizer that contains a lower proportion of nitrogen, such as oxygen or oxygen-enriched air.

In those embodiments of the present invention which seek to maximize the production of electrical energy using the fuel gases produced by the gasification process, it is advantageous to minimize the oxidation of the fuel gas which takes place in the gasification reaction vessel 14. In order to offset any decrease in the production of fuel gas due to partial oxidation conditions, steam may also be used as the oxidizing additive. The use of steam input as a process additive ensures sufficient free oxygen and hydrogen to maximize the conversion of decomposed elements of the input feedstock into fuel gas and/or non-hazardous compounds.

For those embodiments having the production of electrical energy as an objective, it is advantageous to produce gases having a high fuel value. The use of steam as a process additive is known in the art. The gasification of carbonaceous feedstocks in the presence of steam produces a syngas composed predominantly of hydrogen and carbon monoxide. Those of ordinary skill in the chemical arts will recognize that the relative proportions of hydrogen and carbon monoxide in the fuel gas product can be manipulated by introducing different amounts of process additives into the converter.

Steam input ports can be strategically located to direct steam into the high temperature processing zone and/or into the product gas mass prior to its exit from the reaction vessel 14.

### Solid Residue Handling Subsystem

Still referring to FIGS. 1 to 3 and 16 to 20, 29 to 31 the present carbonaceous feedstock gasification system 10 also provides means for managing the solid by-product of the gasification process. In particular, the invention provides a solid residue handling subsystem 16 for the conversion of the solid by-products, or residue, resulting from feedstock-to-energy conversion processes, into a vitrified, homogenous substance having low leachability.

In particular, the invention provides a solid residue handling subsystem 16 in which the solid residue-to-slag conversion is optimized by controlling the plasma heat rate and solid residue input rate to promote full melting and homogenization. In one embodiment, the solid residue handling subsystem comprises a solid residue conditioning chamber 42 (or slag chamber) having a solid residue inlet, a plasma heating means, a slag outlet, optionally one or more ports, and a downstream cooling means for cooling and solidifying the slag into its final form. The integrated control subsystem 200 of the present invention also comprises regulating means 206 to regulate the efficient conversion of the solid residue into slag by providing monitoring means 202 to monitor temperature and pressure throughout the solid residue handling subsystem 16, as well as means to control such operational parameters as the power to the plasma heat source 44 and solid residue input rate.

The solid residue handling subsystem 16 of the present invention is adaptable to treat a solid residue stream coming out of any process that converts the carbonaceous feedstock into different forms of energy. This solid residue is typically in a granular state and may come from one or more sources such as the gasification reaction vessel 14 and optionally the gas quality conditioning subsystem 20. In all cases, the solid residue is heated to a temperature required to convert the solids into a vitrified, homogeneous substance that exhibits extremely low leachability when allowed to cool and solidify. The solid residue handling subsystem therefore ensures that the solid residue is brought up to an adequate temperature to melt and homogenize the solid residue. The solid residue handling subsystem also promotes the capture of polluting solids (i.e., heavy metals) in the slag, as well as the formation of a clean, homogeneous (and potentially commercially valuable) slag product.

In order to ensure complete processing of the solid residue, the solid residue handling subsystem is designed to provide sufficient residence time in the slag chamber 42. In one embodiment, the system provides a residence time of at least 10 minutes. In another embodiment, the solid residue handling subsystem provides a residence time of up to 1 hour. In yet another embodiment, the solid residue handling subsystem provides a residence time of up to 2 hours.

The solid residue, which may take the form of char, ash, slag, or some combination thereof, will be removed, continuously or intermittently, from one or more upstream processes through appropriately adapted outlets and conveyance means as would be known to the skilled worker, according to the requirements of the system and the type of by-product being removed. In one embodiment, the solid residue is pushed into the slag chamber 42 through a system of hoppers and conveying screws.

The solid residue may be added in a continuous manner, for example, by using a rotating screw or auger mechanism. For example, in one embodiment, a screw conveyor is employed to convey ash to a slag chamber 42.

Alternatively, the solid residue can be added in a discontinuous fashion. In one embodiment of the invention, the solid residue input means, attached to the solid residue conditioning chamber 42, may consist of a system of conveying rams. In such an embodiment, limit switches are employed to control the length of the ram stroke so that the amount of material fed into the vessel with each stroke can be controlled.

The solid residue input means will further include a control means such that the input rate of the solid residue can be controlled to ensure optimal melting and homogenization of the solid residue material.

In one embodiment, a plasma heat source 44, is employed to heat and melt the ash into slag. The molten slag, at a temperature of, for example, about 1300° C. to about 1700° C., may be periodically or continuously exhausted from the slag chamber 42 and is thereafter cooled to form a solid slag material. Such slag material may be intended for landfill disposal. Alternatively, the molten slag can be poured into containers to form ingots, bricks tiles or similar construction material. The solid product may further be broken into aggregates for conventional uses.

The solid residue handling subsystem 16, therefore, includes a slag output means through which molten slag is exhausted from the slag chamber 42. The output means may comprise a slag exit port 46, which is typically located at or near the bottom of the chamber 42 to facilitate the natural flow of the molten slag pool out of the chamber. The rate at which the molten slag flows out of the slag chamber may be controlled in a variety of ways that would be apparent to a person skilled in the art. For example, in one embodiment, the temperature differential between the point closest to the plasma heating means and the exit point may be adjusted to control the re-solidification time of the molten slag, e.g., through adjustments in the volume of solid residue material allowed to pool in the chamber.

The slag output means may further be adapted to minimize heating requirements by keeping the slag chamber 42 sealed. In one embodiment, the output means comprises a pour spout or S-trap.

As discussed previously, it may also be advantageous to aim the plume of one or more of the plasma heat sources 44 towards the slag pool at, or around, the slag exit port 46 to maintain the temperature of the molten slag and ensure that the slag exit port 46 remains open through the complete slag extraction period. This practice will also aid in maintaining the slag as homogeneous as possible to guard against the possibility that some incompletely-processed material may inadvertently make its way out of the solid residue handling subsystem 16 during slag extraction.

The molten slag can be extracted from the solid residue handling subsystem in a number of different ways as are understood by those of skill in the art. For example, the slag can be extracted by a batch pour at the end of a processing period, or a continuous pour throughout the full duration of processing. The slag from either pour method can be poured into a water bath, where the water acts as a seal between the external environment and the gasification system. The slag can also be dropped into carts for removal, into a bed of silica sand or into moulds.

The walls of the slag chamber 42 are lined with a refractory material that can be one, or a combination of, conventional refractory materials known in the art which are suitable for use in a chamber for extremely high temperature (e.g., a temperature of about 1300° C. to 1800° C.) non-pressurized reactions. Examples of such refractory materials include, but are not limited to, chromia refractories and high alumina refractories containing alumina, titania, and/or chromia. Selection of an appropriate material for lining the slag chamber is made according to their chemical composition, as well as their ability to resist the corrosive nature of the slag, by virtue of their highly dense (low porosity) microstructures. Corrosion rates can be decreased with lower temperatures or reduced heavy metal contamination. It is advantageous to select a non-wetting refractory material where slagging is present.

A solid residue handling subsystem is designed for highly efficient heat transfer between the plasma gases and the solid residue in melting and homogenizing the solid residue. Thus, factors such as efficient heat transfer, adequate heat temperatures, residence time, molten slag flow, input solid residue volume and composition, etc. are taken into account when designing the solid residue handling subsystem.

As discussed above, the physical design characteristics of the solid residue handling subsystem are determined by a number of factors. These factors include, for example, the composition and volume of the solid residue to be processed. The solid residue that enters the slag chamber may be collected from more than one source simultaneously. Accordingly, the internal configuration and size of the solid residue handling subsystem are dictated by the operational characteristics of the input solid residue to be processed.

Another factor to consider in the design of the solid residue handling subsystem is the residence time required to ensure that the solid residue is brought up to an adequate temperature to melt and homogenize the solid residue.

The type of plasma heating means used, as well as the position and orientation, of the plasma heating means is an additional factor to be considered in the design of the solid residue handling subsystem. The plasma heating means must meet the required temperature for heating the solid residue to required levels to melt and homogenize the solid residue while allowing the resulting molten solid residue to flow out of the chamber.

In one embodiment, the solid residue handling subsystem comprises a slag chamber that can be conveniently removed and replaced in order to minimize downtime due to damage and wear.

The control subsystem 200 of the present invention regulates the efficient conversion of solid residue into slag by providing monitoring means 202 to monitor the temperature and optionally pressure at sites located throughout the solid residue handling subsystem 16, wherein such data are acquired on a continuous or intermittent basis. Monitoring means 202 for monitoring the temperature in the chamber, for example, may be located on the outside wall of the chamber, or inside the refractory at the top, middle and bottom of the chamber. The control subsystem 200 of the present invention also provides regulating means 206 for controlling operational parameters such as the power to the plasma heat source 44 and solid residue input rate.

For example, when the temperature of the melt is too high, the control subsystem 200 may command a drop in the power rating of the plasma heat source 44; conversely, when the temperature of the melt is too low, the control subsystem 200 may command an increase in the power rating of the plasma heat source 44.

In one embodiment, the solid residue handling subsystem 16 can also comprise a means for recovering heat (e.g. plasma heat source cooling means 53 and slag cooling means 55 of FIGS. 21 and 22, which can reduce the amount of waste heat generated. Such heat recovery means can include, for example, heat exchangers. In such an embodiment, the control system can additionally control the operating conditions of the heat exchanger. The heat exchanger can have, for example, a number of temperature sensors, flow control elements, and other such monitoring and regulating means 202, 206.

The slag chamber may also include one or more ports to accommodate additional structural elements/instruments that may optionally be required. For example, a viewport that may include a plurality of closed circuit television ports to maintain operator full visibility of all aspects of processing, including monitoring of the slag exit port 46 for formation of blockages. In another embodiment, the slag chamber may include service ports to allow for entry into the chamber for scrubbing/cleaning, maintenance, and repair. Such ports are known in the art and can include sealable port holes of various sizes.

### Heat Recovery Subsystem

Referring now to FIGS. 1 to 3 and 21 to 25 the present carbonaceous feedstock gasification system 10 also provides means, as in 18, for the recovery of heat from the hot product gas. The heat recovery subsystem 18 comprises one or more gas-to-air heat exchangers, as in 48, whereby the hot product gas is used to provide heated exchange-air. The recovered heat (in the form of the heated exchange-air) may then optionally be used to provide heat to the gasification process, as specifically illustrated in FIGS. 23 and 24, thereby reducing the amount of heat which must be provided by the one or more plasma heat sources 15 required to drive the gasification process. The recovered heat may also be used in industrial or residential heating applications.

In another embodiment, the gas-to-air heat exchanger 48 is employed to heat an oxidant, such as oxygen or oxygen-enriched air, which may then optionally be used to provide heat to the gasification process.

Different classes of gas-to-air heat exchangers 48 may be used in the present system, including shell and tube heat exchangers, both of straight, single-pass design and of U-tube, multiple pass design, as well as plate-type heat exchangers. The selection of appropriate heat exchangers is within the knowledge of the skilled worker.

Due to the significant difference in the ambient air input temperature and hot syngas, each tube in the gas-to-air heat exchanger 48 preferably has its individual expansion bellows to avoid tube rupture. Tube rupture presents a high hazard due to problems resulting from air entering gas mixture. Tube rupture may occur where a single tube becomes plugged and is therefore no longer expanding/contracting with the rest of the tube bundle.

In order to minimize the hazard potential from a tube leak, the system of the present invention further comprises one or more individual temperature transmitters associated with the product gas outlet of the gas-to-air heat exchanger 48. These temperature transmitters are positioned to detect a temperature rise resulting from combustion in the event of having exchange-air leak into the syngas conduit. Detection of such a temperature rise will result in the automatic shut down of the induction air blowers which move the coolant air through the heat recovery system.

The gas-to-air heat exchanger 48 is designed to have product gas flow in the tubes rather than on the shell side. In one embodiment, the product gas flows vertically in a “once through” design, which minimizes areas where build up or erosion from particulate matter could occur. In one embodiment, the process air flows counter-currently on the shell side of the gas-to-air heat exchanger 48.

Optionally, the heat recovery subsystem additionally comprises one or more heat recovery steam generators 50 to generate steam, which can be used as a process additive in the gasification reaction, as specifically illustrated in FIGS. 23 and 25 to drive a steam turbine 52, or to drive rotating process equipment, such as induction blowers. Heat from the product gas is used to heat water to generate steam using a heat exchanging means 50, such as a heat recovery steam generator HRSG (FIGS. 1, 2, 22), a waste heat boiler (FIG. 23), and the like. In one embodiment, the steam produced using heat from the product gas is superheated steam.

With specific reference to FIGS. 23 to 25, the relationship between a gas-to-air heat exchanger, as in 48, and a heat recovery steam generator, as in 50, is depicted in accordance with one embodiment of the invention. The exchange-steam can also be used as a process steam additive during the gasification process to ensure sufficient free oxygen and hydrogen to maximize the conversion of the feedstock into the syngas product.

Steam that is not used within the conversion process or to drive rotating process equipment, may be used for other commercial purposes, such as the production of electricity through the use of steam turbines 52 or in local heating applications or it can be supplied to local industrial clients for their purposes, or it can be used for improving the extraction of oil from the tar sands.

In one embodiment, the heat recovery steam generator (or HRSG) 50 is located downstream from the gas-to-air heat exchanger 48. In another embodiment, the HRSG 50 employed in the present system is a shell and tube heat exchanger. The HRSG 50 is designed such that the syngas flows vertically through the tubes and water is boiled on the shell side.

The gas-to-air heat exchanger 48 and the HRSG 50 are designed with the understanding that some particulate matter will be present in the product gas. The particle size is typically between 0.5 to 350 micron. In one embodiment, the product gas velocities here are also maintained at a level high enough for self-cleaning of the tubes, while minimizing erosion.

If the temperature of the exiting product gas exceeds a predetermined limit, this may be an indication that the tubes are starting to plug, at which time the system should be shut down for maintenance. The heat exchangers are provided, as required, with ports for instrumentation, inspection and maintenance, as well as repair and/or cleaning of the conduits.

In one embodiment of the present invention, the system is run intermittently, i.e., subject to numerous start-up and shut down cycles as required. Therefore, it is important that the equipment must be designed to withstand repeated thermal expansion and contraction.

In order to maximize the amount of sensible heat which can be recovered from the hot product gases, as well as the heated exchange-air and steam produced by the heat recovery system, the conduits between the components is optionally provided with a means for minimizing heat loss to the surrounding environment. Heat loss may be minimized, for example, through the use of an insulating barrier around the conduits, comprising insulating materials as are known in the art, or by designing the plant to minimize lengths of conduits.

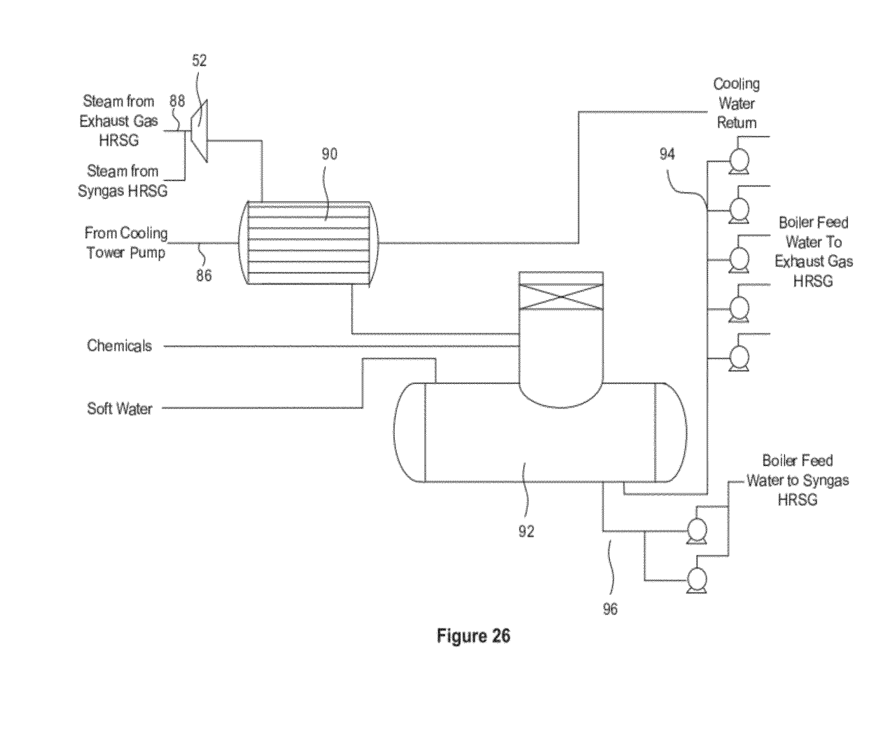

With reference to FIGS. 1 and 26, in one embodiment of the present system 10, the steam recuperated from the outputs of the various steam turbines 52 (e.g. a steam turbine operating from steam generated by an HRSG 50 used to cool the syngas (line 86), a steam turbine operating from steam generated by an HRSG 50 used to cool a gas turbine/engine 24 and exhaust gas generated thereby (line 88), or any combination thereof), is cooled through an additional heat exchanger 90, which is fed by a cooling tower pump or the like. Upon exit from the exchanger 90, the cooled steam/water is pumped through a deaerator 92, fed by a soft water source with appropriate chemicals, to remove air and excess oxygen therefrom, to then be processed back to the boiler feed water of the exhaust gas HRSG 50 (line 94), the syngas HRSG 50 (line 96), etc.

As presented above, the present gasification system 10 also comprises an integrated control subsystem 200 to optimize the transfer of energy throughout the system, thereby managing the energetics of the feedstock-to-energy conversion. The energetics of the feedstock-to-energy conversion can be optimized using the present system, since the recycling of the recovered sensible heat back to the gasification process reduces the amount of energy inputs required from external sources for the steps of drying and volatilizing the feedstock. The recovered sensible heat may also serve to minimize the amount of plasma heat required to achieve a specified quality of syngas. Thus, the present invention allows for the efficient gasification of a carbonaceous feedstock, wherein the gasification heat source is optionally supplemented by air heated using sensible heat recovered from the product gas.

In order to optimize the efficiency of the present invention, the integrated control subsystem 200 also optionally provides a means for controlling the conditions under which the present process is carried out, as well as the operating conditions of the system according to the present invention. These control means, which may be incorporated into the overall integrated control subsystem 200, are provided to monitor one or more parameters, including, but not limited to, temperature and gas flow rates at specified locations throughout the system, and to adjust operating conditions accordingly, so as to maintain the system within defined parameters. Examples of operating conditions which may be adjusted by the control means, via regulating means 206, include one or more of the exchange-air flow rate, the product gas flow rate, the rate of feedstock input, the rate of input of process additives such as steam, and the power to the plasma heat sources 15, 44.

For example, temperature transmitters (and other such monitoring means 202) may be installed at specified locations throughout the system 10. The temperature transmitters may be located to measure, for example, the temperatures of the product gas at the gas-to-air heat exchanger inlet and outlet, as well as the temperatures of the product gas at the HRSG inlet and outlet. Temperature transmitters may also be provided to measure the temperature of the process air after heating in the gas-to-air heat exchanger 48, as well as to measure the temperature of the steam as it exits the HRSG 50.

These temperature measurements can be used to ensure that the temperature of the syngas as it enters a respective heat exchanger does not exceed the ideal operating temperature of that device. For example, if the design temperature for the gas-to-air heat exchanger 48 is 1050° C., a temperature transmitter on the inlet gas stream to the heat exchanger can be used to control both exchange-air flow rates through the system and plasma heat power in order to maintain the optimum syngas temperature. In addition, measurement of the product gas exit temperature may be useful to ensure that the optimum amount of sensible heat has been recovered from the product gas at both heat recovery stages.

A temperature transmitter installed on the air outlet stream to measure the temperature of the heated exchange-air ensures that the process is carried out under conditions that ensure the process air is heated to a temperature appropriate for use in the gasification process. In one embodiment, the exchange-air outlet temperature is, for example, about 600° C., therefore a temperature transmitter installed on the air outlet stream will be used to control one or both of air flow rates through the system and plasma heat source power in the plasma reforming chamber in order to maintain the optimum syngas input temperature, which in turn can be used to control the temperature of the heated exchange-air.

According to one embodiment of the invention, the control strategy sets a fixed set point for the optimum heated exchange-air output temperature, for example, about 600° C., as well as a fixed value for the HRSG gas exit temperature, for example, about 235° C. Therefore, according to this embodiment, when the syngas flow is reduced, the exit gas temperature of the gas-to-air heat exchanger 48 gets cooler, resulting in decreased steam production because the HRSG gas exit temperature is also set to a fixed value.

The same concept applies when the airflow through the system is reduced. According to one embodiment of the present invention, the exit exchange-air temperature remains fixed therefore the exit product gas temperature for the gas-to-air heat exchanger 48 is hotter, therefore producing more steam in the HRSG. However, when airflow through the system is reduced, product gas flow will consequently also reduce, so the increased inlet temperature to the HRSG 50 will only be momentarily high. For example, if airflow is reduced to 50%, the maximum inlet gas temperature that the HRSG 50 would momentarily see is approximately 800° C., which is within the temperature limits of the heat exchanger design.

In addition, regulating means 206 for controlling an automatic valve for venting process air to the atmosphere are also optionally provided and incorporated into the overall system control means 200, if more air than required for the gasification process is preheated. For example, in some instances it is necessary to heat more gas than required for the process due to equipment considerations (e.g. when starting a shutdown procedure). In such instances, the excess exchange-air can be vented as required.

The system may further comprise means for monitoring one or more of syngas composition, feedstock input rate, and process additive input rate (see FIGS. 12 to 15) in order to provide additional information as may be required to implement corrective procedures to maintain optimum processing conditions. Various such monitoring means 202 are known in the art and can be employed in the system of the present invention.

With reference to FIGS. 21 and 22, the heat recovery subsystem 18 described above may also provide for the cooling of the product gas as required for subsequent particulate filtering and gas conditioning steps, namely with regards to the GQCS 20 (e.g. GQCS cooling means 61), as well as provide for the cooling of the plasma heat sources 15, 44 (e.g. source cooling means 53), slag handling and processing means (e.g. slag cooling means 55), etc.

### Gas Quality Conditioning Subsystem

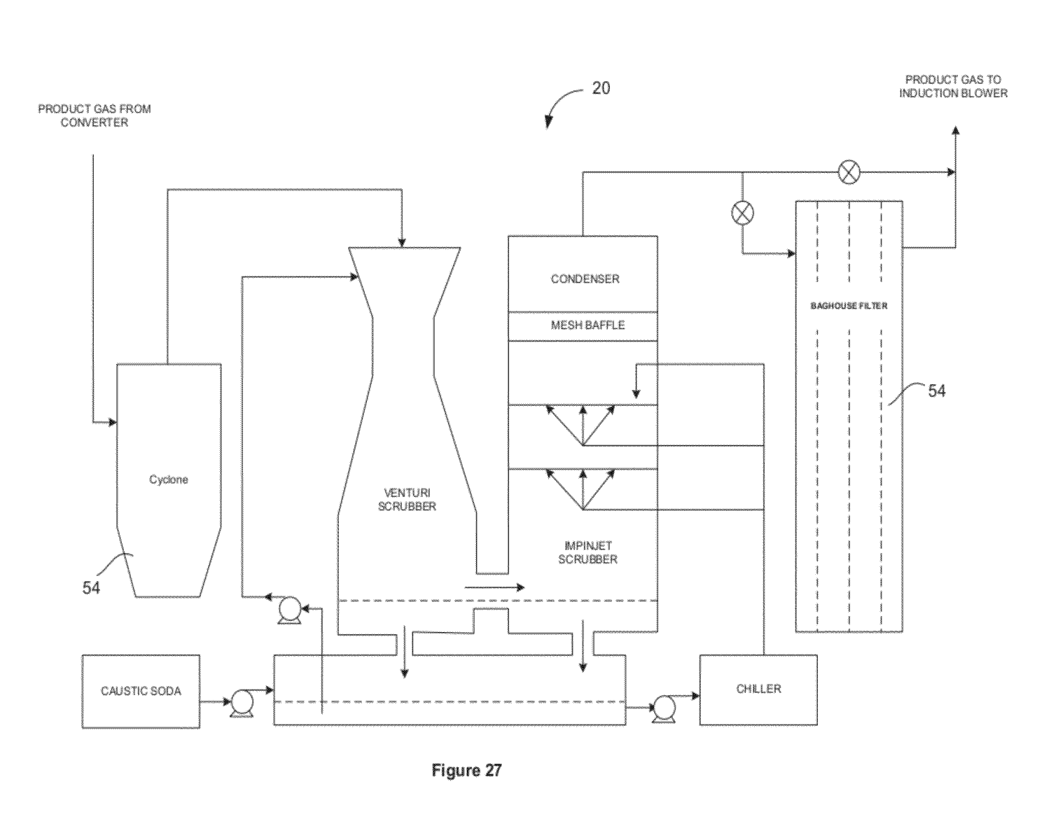

With reference now to FIGS. 3 and 27 the present carbonaceous feedstock gasification system 10 also provides a gas quality conditioning subsystem (GQCS) 20, or other such gas conditioning means, to convert the product of the gasification process to an output gas of specified characteristics.

Passage of the product gas through the GQCS 20 will ensure that the product gas is free of chemical and particulate contaminants, and therefore can be used in an energy generating system or in the manufacture of chemicals. This conditioning step can also be required in those embodiments of the invention which do not have the generation of energy or the manufacture of chemicals as an objective. For example, treatment of the product gas with the gas quality conditioning subsystem 20 can ensure that the product gas can be released through an exhaust mechanism while maintaining strict adherence to local emission standards.

In one embodiment, the objective for the gasification system 10 of the present invention is to produce a fuel gas with specific characteristics (i.e., composition, calorific heating value, purity and pressure) suitable for feeding into a gas turbine 24 for production of renewable electrical energy. Because the fuel is generated by the pyrolysis/gasification of the carbonaceous feedstock through the process described herein, there will exist certain amounts of waste impurities, particulates and/or acid gases which are not suitable to the normal and safe operation of the gas turbines.

The product gas is directed to the GQCS 20, where it is subjected to a particular sequence of processing steps to produce the output gas having the characteristics required for downstream applications. As briefly presented above, the GQCS 20 comprises components that carry out processing steps that may include, but are not limited to, removal of particulate matter 54, acid gases (HCl, H₂S) 56, and/or heavy metals 58 from the synthesis gas, or adjusting the humidity and temperature of the gas as it passes through the system. The presence and sequence of processing steps required is determined by the composition of the synthesis gas and the specified composition of output gas for downstream applications. As presented above, the system 10 also comprises integrated control subsystem 200 to optimize the GQCS process.

In one embodiment, under vacuum extraction conditions of the induction fan of a gasification system, the hot product gas is continuously withdrawn from the gasification system through an exit gas outlet(s) 40 of the gasification system. A gas transfer means, such as a pipe or other conduit is used to transfer the gas from the gasification chamber 14 to the GQCS 20.

It is also contemplated that one or more GQCSs 20 may be used, such as a primary GQCS and a secondary GQCS. In this case, the secondary GQCS may be used to process material such as particulate matter and heavy metals that are removed from the gas stream in the primary GQCS. The output gas from the GQCS 20 can be stored in a gas storage tank 23 (FIG. 2), fed through further processing means such as a homogenization chamber 25 (FIG. 3) or alternatively, fed directly to the downstream application for which it was designed (i.e. FIG. 1).

As discussed above, it is advantageous to provide means for cooling the hot product gas prior to such a conditioning step. This cooling step may be required to prevent damage to heat-sensitive components in the system. In one embodiment, cooling step is carried out by the heat recovery subsystem 18, whereby the heat recovered from the product gas may also be optionally recovered and recycled for use in the gasification process (see FIGS. 23 to 25.

In another embodiment, the gas from the gasification system is first cooled down by direct water evaporation in an evaporator such as quencher (FIG. 3). In yet another embodiment, evaporative cooling towers (dry quench—FIG. 3) may be used to cool the syngas that enters the GQCS 20 from the gasification system. The evaporative cooling tower is capable of cooling the temperature of the syngas from about 740° C. to about 150-200° C. This process may be achieved using adiabatic saturation, which involves direct injection of water into the gas stream in a controlled manner. The evaporating cooling process is a dry quench process, and can be monitored to ensure that the cooled gas is not wet, i.e., that the relative humidity of the cooled gas is still below 100% at the cooled temperature.

As mentioned above, the GQCS 20 may comprise means, as in 54, for removing particulate matter from the optionally cooled gas, as well as gaseous contaminants not compatible with downstream uses of the product gas, such as combustion in gas turbines 24 to produce electricity, or as a feedstock 28 (FIG. 2) in further chemical production processes. A particulate removal system 54 is incorporated to remove particulates that may be entrained in the fuel gas exiting the converter. Particulate removal systems 54 are widely available, and may include, for example, high-temperature (ceramic) filters, cyclone separators (FIG. 6), a venturi scrubber (FIG. 6), an electrofilter, a candle filter, a crossflow filter, a granular filter, a water scrubber, or a fabric baghouse filter (FIG. 3), and the like, which are well known to practitioners of gas conditioning.

As is known in the art, particulates can be removed in a number of ways depending on particulate size. For example, coarse particles may be removed using a cyclone separator or filter. Smaller or finer particles may be removed using Wet ESP or baghouse filters (FIG. 3). In one embodiment, with as much as 10 g/Nm³ particulate loading it a physical barrier that will remove particulate matter with 99.9% efficiency may be required. Wet ESP is driven by an electrostatic field and may not be suitable for use with gas streams of high oxygen content without control mechanisms to trip the current if the oxygen content reaches a particular level.

In one embodiment, a first particle removal means is used to remove coarse particles, and a second particle removal means is used to remove smaller or finer particles. In one embodiment, the first particle removal means is a cyclone filter which can remove particles larger than 5-10 micron in size. In another embodiment, the second particle removal means is a baghouse filter.

Alternative embodiments may change the order of the various gas clean-up steps to use more efficiently the characteristics of alternative gas cleaning devices. However, depending on the specific particulate removal system employed, it may be desirable to cool the fuel gas exiting the reaction vessel 14 before it enters the particulate removal system 54 as previously mentioned. The cooling of the fuel gas may be of particular importance if a bag type filter is used for particulate removal, because bag type filters are often cellulose or organic polymer-based, and cannot withstand extremely high temperatures.

The dust is then collected and may be sent back to the gasification reaction vessel 14 so that no hazardous, solid wastes are produced or generated in the gas conditioning system 20. Alternatively, the particulate may be directed to the slag reservoir (see FIG. 3) to vitrify the scrubber solids into a non-leachable slag. In some cases, depending upon plant considerations and local regulations, solids from the gas clean-up system may be sent off-site for safe disposal.

There may also be provided means, as in 58, for removing mercury or other heavy metals from the product gas. For example, dry injection systems utilize a calculated amount of activated carbon which is injected in the gas stream with enough residence time so that fine heavy metal particles and fumes can adsorb in the activated carbon surface. Heavy metals adsorbed on activated carbon can be captured in a baghouse filter. Alternatively, a wet ESP system may be used to capture the heavy metals adsorbed on activated carbon.

In one embodiment of the invention, the heavy metal particles adsorbed on activated carbon are captured in a baghouse.

An acid scrubbing system is also an effective technique to capture heavy metals. This system requires the passage of the gas containing heavy metals to be passed through a packed column with low pH (normally 1-2) solution circulation. Heavy metals and heavy metal compounds react with acid to form their stable compounds. With this technique the heavy metal concentration in the circulation solution will increase and thus treatment of the resulting waste water may be required. In one embodiment, the GQCS 20 comprises an acid scrubbing system to remove heavy metals.

In one embodiment, the mercury removal means are provided by an activated carbon mercury polisher (FIG. 3). An activated carbon filter bed can be used as the final polishing device for heavy metal. The product gas is passed through activated carbon bed that will adsorb heavy metal (mainly mercury) from the gas stream. Normally activated carbon filters are used to achieve above 99.8-99.9% removal of mercury and used as a final polishing device with 7-8 inches of WC pressure drop.

An acid recovery subsystem 56 is coupled to the gas conditioning system 20, to recover sulfur or sulfuric acid and hydrochloric acid (from chlorinated hydrocarbons), which may have a marketable value. The acid removal system 56 may include scrubber systems (e.g. HCl scrubber 57—FIG. 3), acid removal systems, and other conventional equipment related to sulfur and/or acid removal systems.

The product gas produced in the present gasification system will contain acid gases such as HCl and H₂S. The concentrations of these acid gases in the product gas range from about 0.05 to about 0.5% for HCl, and range from about 100 ppm to about 1000 ppm for H₂S. In one embodiment, the expected concentration of HCl is about 0.178% and H₂S is about 666 ppm (0.07%). The emission limit for HCl is about 5 ppm while for SO₂ it is about 21 ppm.

Acid gas removal can be achieved by dry scrubbing or wet scrubbing. The main components of dry scrubbing are a spray dry absorber and soda ash or lime powder injection before baghouse filtration. Normally with dry scrubbing it is difficult to achieve more than 99% acid removal efficiency.

If the amount of chlorine is of economically significant size, the chlorine may be reclaimed. If chlorine is present in a nuisance amount, it is removed in any suitable manner (e.g. water or wet scrubber, activated bauxite adsorption, etc.). The gas may be treated to remove components such as chlorine in a gas/liquid scrubber-contactor (e.g. HCl scrubber 57). The greatest advantage of wet scrubbing is a large contact area for heat transfer and mass transfer with less pressure drop that will help sub cooling of the gas. Sodium hydroxide is the traditional alkaline solution used for wet scrubbing. In one embodiment, a packed column is used for scrubbing acid gas.

Sulfur compounds are among the first to recombine, either as elemental sulfur, as sulfur-oxygen compounds or sulfur-hydrogen compounds. In one embodiment where the amount of sulfur compounds justifies the cost, the sulfur recovery facility, as in 76, is positioned along the conduit at a location, adjacent the heat exchangers, where a temperature is reached where the sulfur compounds become stable. The type and size of the sulfur recovery facility 76 depends on the expected amount of sulfur in the inlet stream.

If the anticipated amount of sulfur is fairly low, an iron filing technique may be used to react sulfur with elemental iron to produce iron sulfide. This may be accomplished by circulating iron pellets between a compartment in the conduit and a recovery compartment.

For feedstocks that contain a high amount of sulfur, a second-stage liquid washing process is used to remove sulfur compounds from the gas. Sulfur may be recovered by any suitable technique, depending on the amount of sulfur anticipated in the inlet stream. Further downstream, an amine scrubber removes hydrogen sulfide and carbon dioxide from the gas stream leaving a stream mainly comprising hydrogen, carbon monoxide and an inert gas. Such amine scrubbers are known in the art and generally comprise an amine process wherein an aqueous solution of monoethanoloamine, diethanoloamine, or methyldiethanoloamine is used to remove H₂S from the processed gas. Other methods for recovering sulfur may include, for example, a Claus plant, a Resox reduction process, a cold plasma hydrogen sulfide dissociation process, and the like.

In addition, suitable methods for the removal of sulfur include, for example, wet absorption with NaOH or triazine, dry adsorption with Sufatreat, biological processes such as Thiopaq, or selective oxidation, including liquid redox (Low CAT). In one embodiment, H₂S is removed from the synthetic gas using Thiopaq (see FIG. 3). Thiopaq is a two step process in which sour gas is scrubbed with a mild alkaline solution (at 8.5 to 9 pH) and the sulfur subsequently recovered (HS— is oxidized to elemental sulfur by a biological process). Other methods may include, but are not limited to, a moving bed zinc titatna or ferrite adsorption process, oxidation chemical reaction processes (e.g. Stretford and SulFerox), and a selexol acid removal process, the later of which generally involving the use of a physical solvent (e.g. polyethylene glycol dimethyl ether) at high pressures (e.g. 300-1000 psig).

Furthermore, dioxins may be formed at a temperature of 250-350° C. in the presence of carbon that will act as catalyst, although plasma gasification conditions are known to hinder their formation. For additional minimization of dioxin formation, quenching of synthesis gas is normally done in a quencher or spray dryer absorber to ensure fast quenching is done between the above temperature range. Activated carbon injection in the synthesis gas will absorb dioxin and furan on carbon surface, followed by removal in baghouse filters.

Demisters or reheaters could also be incorporated for moisture removal and/or prevention of condensation. Heat exchangers can be included to reheat the fuel gas to the inlet temperature required by the downstream power generation equipment. A compressor can also optionally be included to compress the fuel gas to the inlet pressures required by downstream power generation equipment.

In yet another embodiment, a humidity control means can be part of the GQCS 20. The humidity control means functions to ensure that the humidity of the output gas is appropriate for the downstream application required. For example, a humidity control means may include a chiller to cool the gas stream and thus condense some water out of the gas stream. This water can be removed by a gas/liquid separator. In one embodiment such treatment of the gas stream ensures that the gas stream exiting from the GQCS 20 has a humidity of about 80% at 26° C. The gas may then be stored, for instance in a gas storage device 23 (FIG. 2).

In another embodiment, the gas processing system can include means for the recovery of carbon dioxide and/or means for recovery of ammonia. Suitable means are known in the art.

The product gas is also sampled for gas chromatography (GC) analyses to determine chemical composition. Sample points for these analyses are spread throughout the product gas handling/pollution abatement subsystem.

In one embodiment, the control subsystem 200 comprises means to adjust the operating conditions in the conversion system, including the operating conditions in the GQCS 20, thereby managing the net overall energetics of the conversion process, and maintaining a set point for reaction conditions within a specified range of variability during the conversion of a carbonaceous feedstock to a product gas having a specified chemical and physical composition. This system can be automated and applied to a variety of gasification systems.

The control subsystem 200 may provide the following functions. In one embodiment, the control subsystem 200 may sense decrease in efficiency or alternate functional deficiency in a process of the GQCS 20 and divert the gas stream to a backup process or backup conditioning system. In another embodiment, the control subsystem 200 may provide a means for fine-tuning the steps of the GQCS 20 and providing minimal drift from optimal conditions.

The control subsystem 200 of this invention can include monitoring means 202 for analyzing the chemical composition of the gas stream through the GQCS 20, the gas flow and thermal parameters of the process; and regulating means 206 to adjust the conditions within the GQCS 20 to optimize the efficiency of processing and the composition of the output gas. Ongoing adjustments to the reactants (for example, activated carbon injection with sufficient residence time, pH control for the HCl scrubber) can be executed in a manner which enables this process to be conducted efficiently and optimized according to design specifications.

### Subsystem for Regulating the Product Gas

The present gasification system also optionally provides means for regulating the product gas, for example, by homogenizing the chemical composition of the product gas and adjusting other characteristics such as flow, pressure, and temperature of the product gas to meet downstream requirements. This product gas regulating subsystem 22 enables a continual and steady stream of gas of defined characteristics to be delivered to downstream applications, such as a gas turbine 24 or engine.

As is understood by those skilled in the art, the gasification process may produce gases of fluctuating composition, temperature or flow rates. In order to minimize the fluctuations in the characteristics of the product gas, there is optionally provided a gas regulation subsystem 22 in the form of a capturing means useful for delivering to downstream equipment a product gas having consistent characteristics.

In one embodiment the present invention provides a gas regulation system 22 that collects the gaseous products of the gasification process and attenuates fluctuations in the chemistry of the gas composition in a homogenization chamber 25, or the like. Other elements of the system optionally adjust characteristics of the gas such as flow, temperature and pressure to fall within ranges that are acceptable to the downstream applications. The system thereby regulates the characteristics of the product gas to produce a continual stream of gas with consistent characteristics for delivery to a downstream application, such as a gas engine or a gas turbine 24.

In particular, the product gas regulating subsystem 22 of the present invention provides a gas homogenization chamber 25 (FIG. 3) or the like (e.g. the gas compressor 21 of FIG. 3, the gas storage device 23 of FIG. 2, etc.) having dimensions that are designed to accommodate a residence time sufficient to attain a homogeneous gas of a consistent output composition. Other elements of the present gas regulation system are designed to meet the gas performance requirements of the downstream application. The system also comprises a control subsystem 200 to optimize the energetics and output of the process.

The composition of the product gas entering the regulation system of the present invention is determined in the gasification process. Adjustments made during the gasification process permit the product gas to be optimized for a specific application (e.g., gas turbines 24 or fuel cell application 26 for electricity generation). Accordingly, the composition of the product gas can be tailored for particular energy generating technologies (for example, for specific gas engines or gas turbines 24) and, for best overall conversion efficiency, according to the different types of feedstocks and process additives used, by adjusting the operational parameters of the gasification process.

The product gas leaving the gasification system may be within a defined range of a target composition, however, over time the product gas may fluctuate in its characteristics due to variability in the gasification process such as feedstock composition and feed rate, as well as airflow and temperature fluctuations.

Similar to the control of the composition of the product gas, the flow rate and temperature of the product gas can be monitored, for example via monitoring means 202, and controlled in the gasification system, for example via regulating means 206, in order to maintain the parameters of the gas within predetermined tolerances defined by the end use. Irrespective of these controls, fluctuations in flow rate and temperature of the product gas, over time, will occur. In the case of flow rate, these fluctuations may occur on a second to second basis; and with temperature on a per minute basis. Typical variances in flow rate range from 7200 Nm³ to 9300 Nm³.

Conversion of product gas to a gas having a specified composition that meets the requirements of the particular application equipment, can be effected in the regulation system of the present invention. The regulation system comprises one or more gas homogenization chambers 25, or the like, having a product gas inlet means, a regulated gas outlet means, and optionally an emergency exit port.

The product gas homogenization chamber 25 receives the product gas produced from a gasification system and encourages mixing of the product gas to attenuate any fluctuations in the chemical composition of the product gas in the homogenization chamber 25. Fluctuations in other gas characteristics, such as pressure, temperature and flow rate, will also be reduced during mixing of the product gas.

The dimensions of the chamber are designed according to the performance characteristics of the upstream gasification system and the requirements of the downstream machinery, with the objective of minimizing the size or the chamber as much as possible. The gas homogenization chamber 25 is designed to receive product gas from a gasification process and retain the gas for a certain residence time to allow for sufficient mixing of the gas in order to achieve a volume of gas with a consistent chemical composition.

The residence time is the amount of time that the product gas remains in the homogenization chamber 25 before being directed to the downstream equipment. The residence time is proportional to the response time of the related gasification system to correct for variances in the fluctuations in the gasification reaction in order to achieve a gas composition that falls within accepted tolerance values. For example, the gas composition is retained in the homogenization chamber 25 long enough to determine whether it falls within the gas composition tolerance allowed for the particular downstream application as well as to make any adjustments to the gasification process to correct for the deviance.

Additionally, residence time of the product gas in the homogenization chamber 25 is determined by the amount of variance in the product gas characteristics. That is, the smaller the variance in product gas characteristics, the shorter the residence time required in the homogenization chamber 25 to correct for the variance.

For example, a gas engine may be selected for use with the present gasification system to generate electricity. The selected gas engine will have

[symbol]

The regulated gas exiting the regulation system of the present invention will have stabilized characteristics that meet the specifications of the downstream application. Typically, machine manufacturers will provide the requirements and tolerances allowed by the specific machinery and would be known to the person skilled in the art.

### Use of the Gasification System/the Process

The system according to the present invention gasifies carbonaceous feedstocks, using a process for gasification of the feedstock which generally comprises the steps of passing the feedstock into a gasification reaction vessel 14 where it is heated dried and volatile components in the dried feedstock are volatilized. In one embodiment of the invention, heated air is used to further drive the complete conversion of the resulting char to its gaseous constituents, leaving an ash by-product. The combined products of the drying, volatilization and combustion steps provide an offgas, which is further subjected to the heat from a plasma heat source 15 to convert the offgas to a hot gaseous product comprising carbon monoxide, carbon dioxide, hydrogen and steam. Steam and/or air/oxidant process additives may be optionally added (e.g. via additive input means 38) at the gasification stage and/or the offgas conversion stage.

In one embodiment of the invention, the process further comprises the step of subjecting by-product ash to heating by means of a second plasma heat source 44 to form a slag product.

The process of the present invention further comprises the steps of passing the hot product gas through a heat exchanging subsystem 18, transferring heat from the hot gas to a coolant. In one embodiment, the coolant is air.

The process of the present invention optionally comprises the steps of passing the cooled gas product into a second heat exchanger 18, transferring heat from the cooled gas to a coolant which is water to produce a further cooled gas product and steam.

The process of the present invention maximizes net conversion efficiency by offsetting the amount of electricity that has to be consumed to create the heat which drives the gasification process, to drive rotating machinery, and to power the plasma heat sources 15, 44. For applications having the objective of generating electricity, the efficiency is measured by comparing the energy consumed by the overall gasification process with the amount of energy generated using the product gas (for example, to power gas turbines 24 or in fuel cell technologies 26), and through the recovery of sensible heat to generate steam to power steam turbines 52.

The gasification process can further comprise a feedback control step of adjusting one or more of the feedstock input rate, the product gas flow rate, the air/oxidant and/or steam process additive input rate, the carbon-rich additive input rate and the amount of power supplied to the plasma heat sources based on changes in the flow rate, temperature and/or composition of the product gas. The feedback control step thus allows the flow rate, temperature and/or composition of the product gas to be maintained within acceptable ranges.

In one embodiment of the present invention, the process further comprises the step of pre-heating the feedstock prior to adding to the gasification reaction vessel 14.

In one embodiment, the gasification process according to the present invention employs the use of heated air from the gas-to-air heat exchanger 48 to heat the gasification reaction vessel to a temperature appropriate for gasifying a carbonaceous feedstock. In this embodiment, which is typically used at the start-up phase of the system 10, air is fed into the system, whereby it is heated by plasma heat to provide a hot start-up gas which then enters the gas-air heat exchanger 48 to generate heated air. The heated air is transferred to the heated air inlet means to heat up the gasification reaction vessel 14, such that the entire process can run without the use of fossil fuels.

The invention will now be described with reference to a specific example. It will be understood that the following example is intended to describe an embodiment of the invention and is not intended to limit the invention in any way.

### Example

In general, the system of the present invention is used by feeding the carbonaceous feedstock along with the heat from a source such as a plasma heat source 15, heated air, or any other heat source as may be appropriate, into a gasification reaction vessel 14 where the feedstock is subjected to sufficient heat to allow the gasification reaction to take place.

Heating of the feedstock results in removal of any residual moisture and volatilization of any volatile components, thereby providing a partially oxidized char product. Further heating of the partially oxidized char product completely converts the char to its gaseous constituents, leaving an ash by-product, which can then be further heated and converted to slag.

Extra oxygen may be injected into the gasification reaction vessel to initiate or to increase the exothermic reactions that produce carbon monoxide, carbon dioxide and carbon particles. The exothermic reactions along with the heat optionally provided by the heated process air increase the processing temperature in the gasification reaction vessel 14.

In one embodiment, the processing temperature is between about 100° C. to about 1000° C., although lower and higher temperatures are also contemplated. In one embodiment of the present invention, the process employs an average gasification temperature within the reaction vessel is about 700° C.+/−100° C.

### Reformation

The offgas which is formed in the gasification reaction vessel 14 is further heated with a plasma heat source 15 and optionally treated with steam. These reactions are mainly endothermic. In one embodiment of the present invention, the temperature is maintained in a range that is high enough to keep the reactions at an appropriate level to ensure complete conversion to the specified gas product, while minimizing pollution production. In one embodiment, the temperature range is from about 900° C. to about 1300° C. Appropriate temperature ranges can readily be determined by the skilled worker.

The steam that is added in the reformation step acts to ensure formation of a gas product having a specified composition, while also reducing the exit temperature of the gas. In one embodiment, the exit temperature of the product gas is reduced to between about 900° C. and about 1200° C. In another embodiment, the product gas exit temperature is reduced to an average temperature of about 1000° C.+/−100° C.

The product gas exits the plasma reforming zone at a temperature of about 800° C. to about 1100° C. The flow rate of the hot syngas is about 6000 Nm³/hr to about 9500 Nm³/hr, preferably about 7950 Nm³/hr. The hot product gas then passes into a gas-to-air heat exchanger 48.

In one embodiment of the present invention where heat exchangers 18 are used to cool the hot product gas, air enters the gas-to-air heat exchanger 48 at ambient temperature, i.e., from about −30 to about 40° C. The air is circulated through the system using air blowers, entering the gas-to-air heat exchanger at a rate of about 3000 Nm³/hr to 6000 Nm³/hr, preferably at a rate of about 4000 Nm³/hr to 4500 Nm³/hr, more preferably at a rate of 4350 Nm³/hr.

In one exemplary embodiment, the amount of carbonaceous feedstock, oxygen, steam, carbon-rich additive and power to the plasma heat sources 15 may be determined on the basis of monitoring the flow rate of the exit synthesis gas, the exit temperature of the exit synthesis gas and the composition of the exit gas.

With reference to FIGS. 14 and 15, the numerical value of the flow rate of carbon monoxide and carbon dioxide in the exit gases via lines 100 and 102 is inputted into a first processor (illustrated by logic box 30) along with the numerical value of the feed rate of coal in line 104 (e.g. obtained via regulating means 206-1). The first processor 30 estimates the amount of carbon in the gasification reaction vessel 40 and adjusts the coal feed rate accordingly.

Output from first processor 30, and which provides a measure of the numerical value of the percent carbon monoxide and the percent carbon dioxide is inputted via line 106 to a second processor 32 (illustrated by logic box 32) along with the numerical value of the percent hydrogen via line 108, and the numerical values of steam (e.g. via regulating means 206-2) and oxygen (e.g. via regulating means 206-3) via line 110. The second processor 32 estimates new oxygen and steam inputs to achieve the specified gas composition.

Output from the second processor 32 are inputted into a third processor 34 via line 112 along with an input representative of the numerical value of the exit gas temperature via line 114. The third processor 34 computes new plasma heat source power (e.g. plasma torch power) which outputs as plasma heat source power output (e.g. sent to regulating means 206-4) via line 116.

Referring back to FIGS. 1 to 3, in one embodiment of the invention, the air is heated in the heat exchanger 48 to produce heated air having a temperature of about 500° C. to about 800° C., preferably to about 600° C. The hot product gas, in turn, is cooled to a temperature of about 500° C. to about 800° C., preferably to about 730° C. The heated air is optionally used in the gasification reaction vessel 14 to gasify the carbonaceous feedstock, as discussed above.

Further sensible heat is recovered from the product gas after it exits from the gas-to-air heat exchanger 48 through the use of a heat recovery steam generator (HRSG) 50. The product gas enters the HRSG 50 at a temperature of about 500° C. to about 800° C., preferably at a temperature of about 730° C.

The HRSG 50 transfers heat from the hot product gas to a water input to produce a saturated steam having a temperature of about 180° C. to about 250° C., preferably about 235° C., at a pressure of about 250 psig to about 350 psig, preferably about 300 psig. In one embodiment, the water input into the steam generator is available at about 50° C. to 95° C., preferably at about 90° C.

In one embodiment, the cooled syngas is further passed through a gas conditioning stage (e.g. GQCS 20). Therefore, the product gas temperature at the HRSG exit should preferably not exceed 235° C.

After the gas conditioning stage, the product gas is optionally stored in a homogenization chamber 25 (FIG. 3), or the like.

### Melting of By-Product Ash

In one embodiment of the invention, the solid ash by-product of the char combustion step is further optionally processed by melting with a second plasma heat source 44. Enough time is allowed when the particles are entrained in the slag pool to ensure that all volatiles and carbon are completely removed. As would be appreciated by a worker skilled in the art, the residence time is a function of the particle size. The heat produced by the second plasma heat source 44 homogenizes the slag and allows it to be extracted while hot. The plasma heat source 44 heats the slag to a temperature between about 1100° C. and about 1600° C. In one embodiment, to temperature is between about 1400° C. and about 1650° C. This manipulation of the temperature profiles can help to avoid wasting heat and later water to quench the slag in the bottom of the gasification reaction vessel 14.

Although the invention has been described with reference to certain specific embodiments, various modifications thereof will be apparent to those skilled in the art without departing from the spirit and scope of the invention as outlined in the claims appended hereto.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

We claim:

1. A system for the conversion of a carbonaceous feedstock to a gas of a specified composition, comprising:
a gasification reaction vessel comprising:
one or more processing zones,
one or more plasma heat sources,
one or more carbonaceous feedstock input means for adding the carbonaceous feedstock to the gasification reaction vessel at an adjustable carbonaceous feedstock feed rate,
one or more process additive input means for adding process additives to the gasification reaction vessel at an adjustable process additive feed rate,
one or more carbon-rich material additive input means for adding carbon-rich material additives to the gasification reaction vessel at an adjustable carbon-rich material additives feed rate, and
one or more outlets for the output gas,
a solid residue handling subsystem;
a gas quality conditioning subsystem; and
an integrated control system comprising:
system monitoring means for measuring one or more system parameters to generate data,
computing means for collecting and analyzing the data generated by the system monitoring means, and
output means to send appropriate signals to effect change in one or more system regulators located throughout the system,
wherein the control system monitors the one or more system parameters and sends signals to the appropriate system regulators to effect change in the one or more system regulators and thereby produce a product gas of a specified composition.

2. The system according to claim 1, further comprising a heat recovery subsystem, wherein the heat recovery subsystem comprises one or more gas-to-air heat exchangers, and means to transfer the product gases to the one or more gas-to-air heat exchangers, wherein the transfer means is in fluid communication with the one or more output gas outlets.

3. The system according to claim 2, wherein the heat recovery subsystem further comprises one or more heat recovery steam generators, and means to transfer the product gases to the one or more heat recovery steam generators.

4. The system according to claim 1 or 2, wherein the gas quality conditioning subsystem comprises one or more of a particulate matter removal means, an acid gas removal means, a heavy metals removal means, and a means for adjusting the humidity and temperature of the gas as it passes through the gas quality conditioning subsystem.

5. The system according to claim 1 or 2, further comprising a product gas regulating subsystem.

6. The system according to claim 5, wherein the product gas regulating subsystem is a homogenization tank.

7. The system according to claim 1, wherein the process additive input means is one or more steam inlets, one or more oxidant inlets or both.

8. The system according to claim 7, wherein the oxidant is air, oxygen or oxygen-enriched air.

9. The system according to claim 1, wherein the solid residue handling subsystem comprises a solid residue conditioning chamber, a plasma heating means, and a slag output means.
